(19) United States
(12) Patent Application Publication
(10) Pub. No.: US 2020/0362686 A1
(43) Pub. Date: Nov. 19, 2020

(54) Machine Learning Drill Out System

(71) Applicant: Schlumberger Technology Corporation, Sugar Land, TX (US)

(72) Inventors: Arifin Puwanto, Houston, TX (US); Vishal Saheta, Houston, TX (US); Erik Eriksen, Calgary (CA)

(21) Appl. No.: 15/929,674

(22) Filed: May 15, 2020

Related U.S. Application Data
(60) Provisional application No. 62/848,394, filed on May 15, 2019.

(51) Int. Cl. E21B 44/00; E21B 47/12; G06N 3/08; G06N 20/00

(52) U.S. Cl. CPC E21B 44/00; G06N 20/00; G06N 3/088; E21B 47/12

(57) ABSTRACT

A machine learning drill out system includes a method of receiving data, associated with a drill out, by a trained machine learning model. The method also includes generating, via the trained machine learning model, output that characterizes the drill out. The method may include rendering a representation of the output to a display, providing a recommendation to a user, providing a control instruction for a well site system, adjusting at least one drilling parameter of the drill out based at least in part on the output, or any combination thereof.

### CROSS-REFERENCE TO RELATED APPLICATIONS

This application claims the benefit of, and priority to, U.S. Patent Application No. 62/848,394 filed on May 15, 2019, which is incorporated herein by this reference in its entirety.

### BACKGROUND

Drilling equipment may be utilized to drill into rock of a geologic region, for example, to form a borehole and drilling equipment may be utilized to drill into material (e.g., a component, an assembly, cement, etc.) that may be placed in a borehole, which can be referred to as a drill out.

### SUMMARY

A method can include receiving data, associated with a drill out, by a trained machine learning model; and generating, via the trained machine learning model, output that characterizes the drill out. A system can include a processor; memory accessible to the processor; processor-executable instructions stored in the memory and executable by the processor to instruct the system to: receive data, associated with a drill out, by a trained machine learning model; and generate, via the trained machine learning model, output that characterizes the drill out. One or more computer-readable storage media can include computer-executable instructions executable to instruct a computing system to: receive data, associated with a drill out, by a trained machine learning model; and generate, via the trained machine learning model, output that characterizes the drill out. Various other apparatuses, systems, methods, etc., are also disclosed.

This summary is provided to introduce a selection of concepts that are further described below in the detailed description. This summary is not intended to identify key or essential features of the claimed subject matter, nor is it intended to be used as an aid in limiting the scope of the claimed subject matter.

### BRIEF DESCRIPTION OF THE DRAWINGS

Features and advantages of the described implementations can be more readily understood by reference to the following description taken in conjunction with the accompanying drawings.

FIG. 1 illustrates examples of equipment in a geologic environment;

FIG. 2 illustrates an example of a wellsite system and examples of types of holes;

FIG. 3 illustrates an example of a data system;

FIG. 4 illustrates an example of a wellsite system;

FIG. 5 illustrates an example of a cemented system;

FIG. 6 illustrates an example of a liner system;

FIG. 7 illustrates an example of a system;

FIG. 8 illustrates an example of a pump down displacement plug assembly;

FIG. 9 illustrates an example of a casing string system;

FIG. 10 illustrates an example of a cemented casing system;

FIG. 11 illustrates an example of a system;

FIG. 12 illustrates an example of an architecture of a framework;

FIG. 13 illustrates an example of equipment in a geologic environment;

FIG. 14 illustrates an example of a graphical user interface;

FIG. 15 illustrates an example of a machine learning training method;

FIG. 16 illustrates an example of a method;

FIG. 17 illustrates an example of a graphical user interface;

FIG. 18 illustrates an example of a graphical user interface;

FIG. 19 illustrates an example of a graphical user interface;

FIG. 20 illustrates an example of a graphical user interface;

FIG. 21 illustrates an example of a graphical user interface;

FIG. 22 illustrates examples of computing and networking equipment; and

FIG. 23 illustrates example components of a system and a networked system.

### DETAILED DESCRIPTION

The following description includes embodiments of the best mode presently contemplated for practicing the described implementations. This description is not to be taken in a limiting sense, but rather is made merely for the purpose of describing the general principles of the implementations. The scope of the described implementations should be ascertained with reference to the issued claims.

Various operations can be performed in a field. For example, consider exploration as an initial phase in petroleum operations that includes generation of a prospect or play or both, and drilling of an exploration well or borehole. Appraisal, development and production phases may follow successful exploration.

A borehole may be referred to as a wellbore and can include an openhole portion or an uncased portion and/or may include a cased portion. A borehole may be defined by a bore wall that is composed of a rock that bounds the borehole.

As to a well or a borehole, whether for one or more of exploration, sensing, production, injection or other operation(s), it can be planned. Such a process may be referred to generally as well planning, a process by which a path can be mapped in a geologic environment. Such a path may be referred to as a trajectory, which can include coordinates in a three-dimensional coordinate system where a measure along the trajectory may be a measured depth, a total vertical depth or another type of measure. During drilling, wireline investigations, etc., equipment may be moved into and/or out of a well or borehole. Such operations can occur over time and may differ with respect to time. As an example, drilling can include using one or more logging tools that can perform one or more logging operations while drilling or otherwise with a drillstring (e.g., while stationary, while tripping in, tripping out, etc.). As an example, a wireline operation can include using one or more logging tools that can perform one or more logging operations. A planning process may call for performing various operations, which may be serial, parallel, serial and parallel, etc.

As an example, a well plan can be generated based at least in part on imposed constraints and known information. As an example, a well plan may be provided to a well owner, approved, and then implemented by a drilling service provider (e.g., a directional driller or “DD”). In such an example, a rig may be used to drill, for example, according to a well plan. During a period of time during which a well plan is implemented, a rig may transition from one state to another state, which may be referred to as rigstates. As an example, a state may be a drilling state or may be a state where drilling into a formation (e.g., rock) is not occurring (e.g., an idle state, a tripping-in state, a tripping-out state, etc.).

As an example, a well design system can account for one or more capabilities of a drilling system or drilling systems that may be utilized at a wellsite. As an example, a drilling engineer may be called upon to take such capabilities into account, for example, as one or more of various designs and specifications are created. As an example, a state such as a rigstate may correspond to a capability, for example, while the capability is being utilized.

As an example, a well design system, which may be a well planning system, may take into account automation. For example, where a wellsite includes wellsite equipment that can be automated, for example, via a local and/or a remote automation command, a well plan may be generated in digital form that can be utilized in a well drilling system where at least some amount of automation is possible and desired. For example, a digital well plan can be accessible by a well drilling system where information in the digital well plan can be utilized via one or more automation mechanisms of the well drilling system to automate one or more operations at a wellsite.

As an example, drilling or one or more other operations may occur responsive to measurements (e.g., surface and/or downhole). For example, a logging while drilling operation may acquire measurements and adjust drilling based at least in part on such measurements. As an example, a logging operation can include moving a logging tool, stopping a logging tool, or otherwise controlling a logging tool based at least in part on measurements acquired by the logging tool or, for example, another logging tool (e.g., sensor unit, etc.).

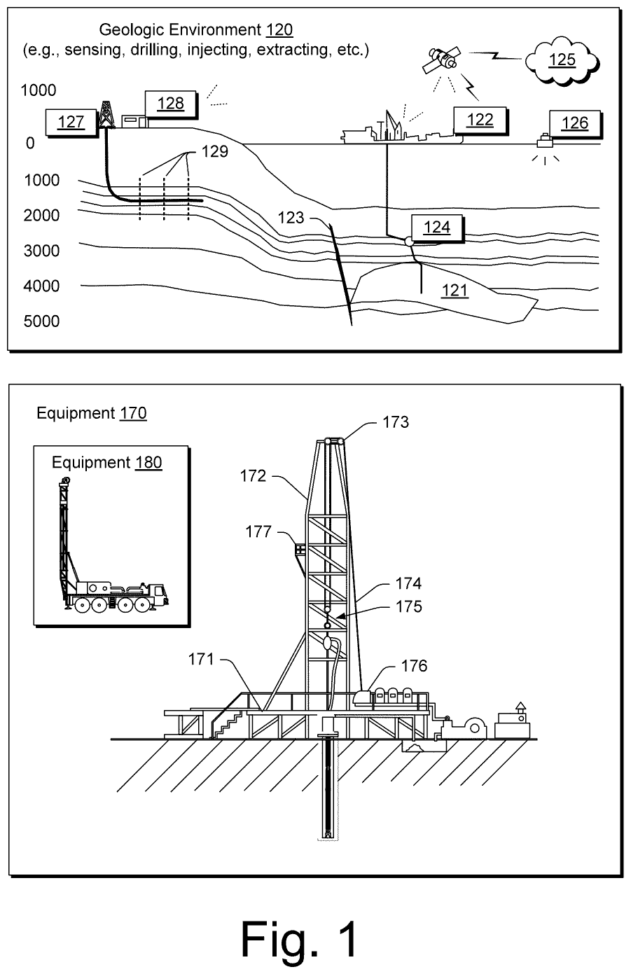

FIG. 1 shows an example of a geologic environment 120. In FIG. 1, the geologic environment 120 may be a sedimentary basin that includes layers (e.g., stratification) that include a reservoir 121 and that may be, for example, intersected by a fault 123 (e.g., or faults). As an example, the geologic environment 120 may be outfitted with a variety of sensors, detectors, actuators, etc. For example, equipment 122 may include communication circuitry to receive and/or to transmit information with respect to one or more networks 125. Such information may include information associated with downhole equipment 124, which may be equipment to acquire information, to assist with resource recovery, etc. Other equipment 126 may be located remote from a well site and include sensing, detecting, emitting or other circuitry. Such equipment may include storage and communication circuitry to store and to communicate data, instructions, etc. As an example, one or more pieces of equipment may provide for measurement, collection, communication, storage, analysis, etc. of data (e.g., for one or more produced resources, etc.). As an example, one or more satellites may be provided for purposes of communications, data acquisition, geolocation, etc. For example, FIG. 1 shows a satellite in communication with the network 125 that may be configured for communications, noting that the satellite may additionally or alternatively include circuitry for imagery (e.g., spatial, spectral, temporal, radiometric, etc.).

FIG. 1 also shows the geologic environment 120 as optionally including equipment 127 and 128 associated with a well that includes a substantially horizontal portion that may intersect with one or more fractures 129. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop the reservoir (e.g., via fracturing, injecting, extracting, etc.). As an example, the equipment 127 and/or 128 may include components, a system, systems, etc. for fracturing, seismic sensing, analysis of seismic data, NMR logging, assessment of one or more fractures, injection, production, etc. As an example, the equipment 127 and/or 128 may provide for measurement, collection, communication, storage, analysis, etc. of data such as, for example, formation data, fluid data, production data (e.g., for one or more produced resources), etc. As an example, one or more satellites may be provided for purposes of communications, data acquisition, etc.

FIG. 1 also shows an example of equipment 170 and an example of equipment 180. Such equipment, which may be systems of components, may be suitable for use in the geologic environment 120. While the equipment 170 and 180 are illustrated as land-based, various components may be suitable for use in an offshore system. As shown in FIG. 1, the equipment 180 can be mobile as carried by a vehicle; noting that the equipment 170 can be assembled, disassembled, transported and re-assembled, etc.

The equipment 170 includes a platform 171, a derrick 172, a crown block 173, a line 174, a traveling block assembly 175, drawworks 176 and a landing 177 (e.g., a monkeyboard). As an example, the line 174 may be controlled at least in part via the drawworks 176 such that the traveling block assembly 175 travels in a vertical direction with respect to the platform 171. For example, by drawing the line 174 in, the drawworks 176 may cause the line 174 to run through the crown block 173 and lift the traveling block assembly 175 skyward away from the platform 171; whereas, by allowing the line 174 out, the drawworks 176 may cause the line 174 to run through the crown block 173 and lower the traveling block assembly 175 toward the platform 171. Where the traveling block assembly 175 carries pipe (e.g., casing, etc.), tracking of movement of the traveling block 175 may provide an indication as to how much pipe has been deployed.

A derrick can be a structure used to support a crown block and a traveling block operatively coupled to the crown block at least in part via line. A derrick may be pyramidal in shape and offer a suitable strength-to-weight ratio. A derrick may be movable as a unit or in a piece by piece manner (e.g., to be assembled and disassembled).

As an example, drawworks may include a spool, brakes, a power source and assorted auxiliary devices. Drawworks may controllably reel out and reel in line. Line may be reeled over a crown block and coupled to a traveling block to gain mechanical advantage in a “block and tackle” or “pulley” fashion. Reeling out and in of line can cause a traveling block (e.g., and whatever may be hanging underneath it), to be lowered into or raised out of a bore. Reeling out of line may be powered by gravity and reeling in by a motor, an engine, etc. (e.g., an electric motor, a diesel engine, etc.).

As an example, a crown block can include a set of pulleys (e.g., sheaves) that can be located at or near a top of a derrick or a mast, over which line is threaded. A traveling block can include a set of sheaves that can be moved up and down in a derrick or a mast via line threaded in the set of sheaves of the traveling block and in the set of sheaves of a crown block. A crown block, a traveling block and a line can form a pulley system of a derrick or a mast, which may enable handling of heavy loads (e.g., drillstring, pipe, casing, liners, etc.) to be lifted out of or lowered into a bore. As an example, line may be about a centimeter to about five centimeters in diameter as, for example, steel cable. Through use of a set of sheaves, such line may carry loads heavier than the line could support as a single strand.

As an example, a derrick person may be a rig crew member that works on a platform attached to a derrick or a mast. A derrick can include a landing on which a derrick person may stand. As an example, such a landing may be about 10 meters or more above a rig floor. In an operation referred to as trip out of the hole (TOH), a derrick person may wear a safety harness that enables leaning out from the work landing (e.g., monkeyboard) to reach pipe in located at or near the center of a derrick or a mast and to throw a line around the pipe and pull it back into its storage location (e.g., fingerboards), for example, until it a time at which it may be desirable to run the pipe back into the bore. As an example, a rig may include automated pipe-handling equipment such that the derrick person controls the machinery rather than physically handling the pipe.

As an example, a trip may refer to the act of pulling equipment from a bore and/or placing equipment in a bore. As an example, equipment may include a drillstring that can be pulled out of the hole and/or place or replaced in the hole. As an example, a pipe trip may be performed where a drill bit has dulled or has otherwise ceased to drill efficiently and is to be replaced.

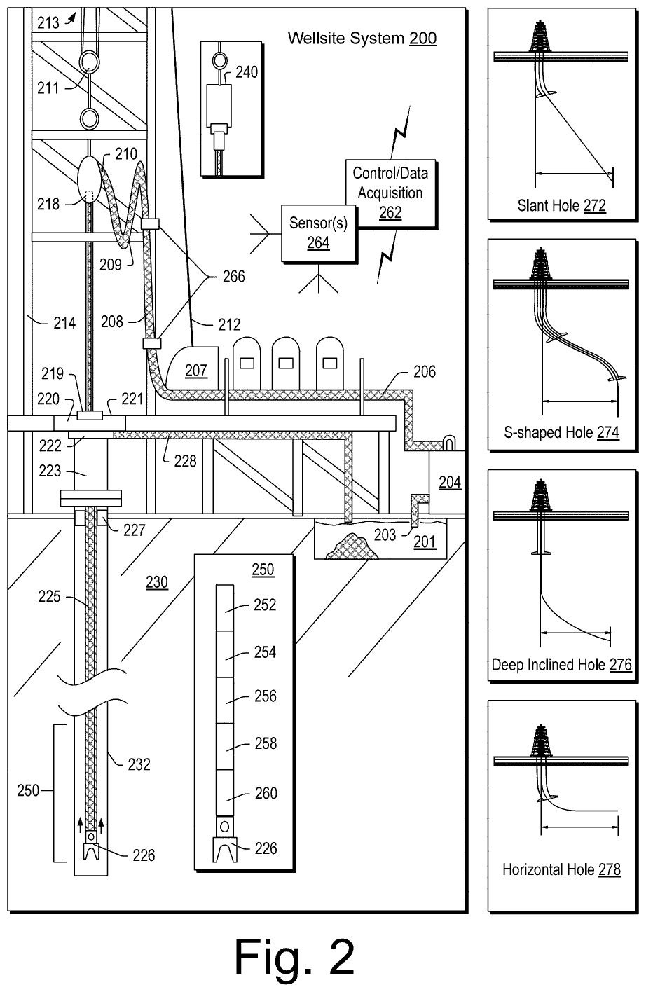

FIG. 2 shows an example of a wellsite system 200 (e.g., at a wellsite that may be onshore or offshore). As shown, the wellsite system 200 can include a mud tank 201 for holding mud and other material (e.g., where mud can be a drilling fluid that may help to transport cuttings, etc.), a suction line 203 that serves as an inlet to a mud pump 204 for pumping mud from the mud tank 201 such that mud flows to a vibrating hose 206, a drawworks 207 for winching drill line or drill lines 212, a standpipe 208 that receives mud from the vibrating hose 206, a kelly hose 209 that receives mud from the standpipe 208, a gooseneck or goosenecks 210, a traveling block 211, a crown block 213 for carrying the traveling block 211 via the drill line or drill lines 212 (see, e.g., the crown block 173 of FIG. 1), a derrick 214 (see, e.g., the derrick 172 of FIG. 1), a kelly 218 or a top drive 240, a kelly drive bushing 219, a rotary table 220, a drill floor 221, a bell nipple 222, one or more blowout preventors (BOPs) 223, a drillstring 225, a drill bit 226, a casing head 227 and a flow pipe 228 that carries mud and other material to, for example, the mud tank 201.

In the example system of FIG. 2, a borehole 232 is formed in subsurface formations 230 by rotary drilling; noting that various example embodiments may also use directional drilling or one or more other types of drilling.

As shown in the example of FIG. 2, the drillstring 225 is suspended within the borehole 232 and has a drillstring assembly 250 that includes the drill bit 226 at its lower end. As an example, the drillstring assembly 250 may be a bottom hole assembly (BHA).

The wellsite system 200 can provide for operation of the drillstring 225 and other operations. As shown, the wellsite system 200 includes the platform 215 and the derrick 214 positioned over the borehole 232. As mentioned, the wellsite system 200 can include the rotary table 220 where the drillstring 225 passes through an opening in the rotary table 220.

As shown in the example of FIG. 2, the wellsite system 200 can include the kelly 218 and associated components, etc., or a top drive 240 and associated components. As to a kelly example, the kelly 218 may be a square or hexagonal metal/alloy bar with a hole drilled therein that serves as a mud flow path. The kelly 218 can be used to transmit rotary motion from the rotary table 220 via the kelly drive bushing 219 to the drillstring 225, while allowing the drillstring 225 to be lowered or raised during rotation. The kelly 218 can pass through the kelly drive bushing 219, which can be driven by the rotary table 220. As an example, the rotary table 220 can include a master bushing that operatively couples to the kelly drive bushing 219 such that rotation of the rotary table 220 can turn the kelly drive bushing 219 and hence the kelly 218. The kelly drive bushing 219 can include an inside profile matching an outside profile (e.g., square, hexagonal, etc.) of the kelly 218; however, with slightly larger dimensions so that the kelly 218 can freely move up and down inside the kelly drive bushing 219.

As to a top drive example, the top drive 240 can provide functions performed by a kelly and a rotary table. The top drive 240 can turn the drillstring 225. As an example, the top drive 240 can include one or more motors (e.g., electric and/or hydraulic) connected with appropriate gearing to a short section of pipe called a quill, that in turn may be screwed into a saver sub or the drillstring 225 itself. The top drive 240 can be suspended from the traveling block 211, so the rotary mechanism is free to travel up and down the derrick 214. As an example, a top drive 240 may allow for drilling to be performed with more joint stands than a kelly/rotary table approach.

In the example of FIG. 2, the mud tank 201 can hold mud, which can be one or more types of drilling fluids. As an example, a wellbore may be drilled to produce fluid, inject fluid or both (e.g., hydrocarbons, minerals, water, etc.).

In the example of FIG. 2, the drillstring 225 (e.g., including one or more downhole tools) may be composed of a series of pipes threadably connected together to form a long tube with the drill bit 226 at the lower end thereof. As the drillstring 225 is advanced into a wellbore for drilling, at some point in time prior to or coincident with drilling, the mud may be pumped by the pump 204 from the mud tank 201 (e.g., or other source) via a the lines 206, 208 and 209 to a port of the kelly 218 or, for example, to a port of the top drive 240. The mud can then flow via a passage (e.g., or passages) in the drillstring 225 and out of ports located on the drill bit 226 (see, e.g., a directional arrow). As the mud exits the drillstring 225 via ports in the drill bit 226, it can then circulate upwardly through an annular region between an outer surface(s) of the drillstring 225 and surrounding wall(s) (e.g., open borehole, casing, etc.), as indicated by directional arrows. In such a manner, the mud lubricates the drill bit 226 and carries heat energy (e.g., frictional or other energy) and formation cuttings to the surface where the mud (e.g., and cuttings) may be returned to the mud tank 201, for example, for recirculation (e.g., with processing to remove cuttings, etc.).

The mud pumped by the pump 204 into the drillstring 225 may, after exiting the drillstring 225, form a mudcake that lines the wellbore which, among other functions, may reduce friction between the drillstring 225 and surrounding wall(s) (e.g., borehole, casing, etc.). A reduction in friction may facilitate advancing or retracting the drillstring 225. During a drilling operation, the entire drillstring 225 may be pulled from a wellbore and optionally replaced, for example, with a new or sharpened drill bit, a smaller diameter drillstring, etc. As mentioned, the act of pulling a drillstring out of a hole or replacing it in a hole is referred to as tripping. A trip may be referred to as an upward trip or an outward trip or as a downward trip or an inward trip depending on trip direction.

As an example, consider a downward trip where upon arrival of the drill bit 226 of the drillstring 225 at a bottom of a wellbore, pumping of the mud commences to lubricate the drill bit 226 for purposes of drilling to enlarge the wellbore. As mentioned, the mud can be pumped by the pump 204 into a passage of the drillstring 225 and, upon filling of the passage, the mud may be used as a transmission medium to transmit energy, for example, energy that may encode information as in mud-pulse telemetry.

As an example, mud-pulse telemetry equipment may include a downhole device configured to effect changes in pressure in the mud to create an acoustic wave or waves upon which information may modulated. In such an example, information from downhole equipment (e.g., one or more components of the drillstring 225) may be transmitted uphole to an uphole device, which may relay such information to other equipment for processing, control, etc.

As an example, telemetry equipment may operate via transmission of energy via the drillstring 225 itself. For example, consider a signal generator that imparts coded energy signals to the drillstring 225 and repeaters that may receive such energy and repeat it to further transmit the coded energy signals (e.g., information, etc.).

As an example, the drillstring 225 may be fitted with telemetry equipment 252 that includes a rotatable drive shaft, a turbine impeller mechanically coupled to the drive shaft such that the mud can cause the turbine impeller to rotate, a modulator rotor mechanically coupled to the drive shaft such that rotation of the turbine impeller causes said modulator rotor to rotate, a modulator stator mounted adjacent to or proximate to the modulator rotor such that rotation of the modulator rotor relative to the modulator stator creates pressure pulses in the mud, and a controllable brake for selectively braking rotation of the modulator rotor to modulate pressure pulses. In such example, an alternator may be coupled to the aforementioned drive shaft where the alternator includes at least one stator winding electrically coupled to a control circuit to selectively short the at least one stator winding to electromagnetically brake the alternator and thereby selectively brake rotation of the modulator rotor to modulate the pressure pulses in the mud.

In the example of FIG. 2, an uphole control and/or data acquisition system 262 may include circuitry to sense pressure pulses generated by telemetry equipment 252 and, for example, communicate sensed pressure pulses or information derived therefrom for process, control, etc.

The assembly 250 of the illustrated example includes a logging-while-drilling (LWD) module 254, a measurement-while-drilling (MWD) module 256, an optional module 258, a rotary-steerable system (RSS) and/or motor 260, and the drill bit 226. Such components or modules may be referred to as tools where a drillstring can include a plurality of tools.

As to a RSS, it involves technology utilized for direction drilling. Directional drilling involves drilling into the Earth to form a deviated bore such that the trajectory of the bore is not vertical; rather, the trajectory deviates from vertical along one or more portions of the bore. As an example, consider a target that is located at a lateral distance from a surface location where a rig may be stationed. In such an example, drilling can commence with a vertical portion and then deviate from vertical such that the bore is aimed at the target and, eventually, reaches the target. Directional drilling may be implemented where a target may be inaccessible from a vertical location at the surface of the Earth, where material exists in the Earth that may impede drilling or otherwise be detrimental (e.g., consider a salt dome, etc.), where a formation is laterally extensive (e.g., consider a relatively thin yet laterally extensive reservoir), where multiple bores are to be drilled from a single surface bore, where a relief well is desired, etc.

One approach to directional drilling involves a mud motor; however, a mud motor can present some challenges depending on factors such as rate of penetration (ROP), transferring weight to a bit (e.g., weight on bit, WOB) due to friction, etc. A mud motor can be a positive displacement motor (PDM) that operates to drive a bit during directional drilling. A PDM operates as drilling fluid is pumped through it where the PDM converts hydraulic power of the drilling fluid into mechanical power to cause the bit to rotate. A PDM can operate in a so-called sliding mode, when the drillstring is not rotated from the surface.

A RSS can drill directionally where there is continuous rotation from surface equipment, which can alleviate the sliding of a steerable motor (e.g., a PDM). A RSS may be deployed when drilling directionally (e.g., deviated, horizontal, or extended-reach wells). A RSS can aim to minimize interaction with a borehole wall, which can help to preserve borehole quality. A RSS can aim to exert a relatively consistent side force akin to stabilizers that rotate with the drillstring or orient the bit in the desired direction while continuously rotating at the same number of rotations per minute as the drillstring.

The LWD module 254 may be housed in a suitable type of drill collar and can contain one or a plurality of selected types of logging tools (e.g., NMR unit or units, etc.). It will also be understood that more than one LWD and/or MWD module can be employed, for example, as represented at by the module 256 of the drillstring assembly 250. Where the position of an LWD module is mentioned, as an example, it may refer to a module at the position of the LWD module 254, the module 256, etc. An LWD module can include capabilities for measuring, processing, and storing information, as well as for communicating with the surface equipment. In the illustrated example, the LWD module 254 may include a seismic measuring device, a NMR measuring device, etc.

The MWD module 256 may be housed in a suitable type of drill collar and can contain one or more devices for measuring characteristics of the drillstring 225 and the drill bit 226. As an example, the MWD tool 254 may include equipment for generating electrical power, for example, to power various components of the drillstring 225. As an example, the MWD tool 254 may include the telemetry equipment 252, for example, where the turbine impeller can generate power by flow of the mud; it being understood that other power and/or battery systems may be employed for purposes of powering various components. As an example, the MWD module 256 may include one or more of the following types of measuring devices: a weight-on-bit measuring device, a torque measuring device, a vibration measuring device, a shock measuring device, a stick slip measuring device, a direction measuring device, and an inclination measuring device.

As an example, one or more NMR measuring devices (e.g., NMR units, etc.) may be included in a drillstring (e.g., a BHA, etc.) where, for example, measurements may support one or more of geosteering, geostopping, trajectory optimization, etc.

FIG. 2 also shows some examples of types of holes that may be drilled. For example, consider a slant hole 272, an S-shaped hole 274, a deep inclined hole 276 and a horizontal hole 278.

As an example, a drilling operation can include directional drilling where, for example, at least a portion of a well includes a curved axis. For example, consider a radius that defines curvature where an inclination with regard to the vertical may vary until reaching an angle between about 30 degrees and about 60 degrees or, for example, an angle to about 90 degrees or possibly greater than about 90 degrees. As an example, a trajectory and/or a drillstring may be characterized in part by a dogleg severity (DLS), which can be a two-dimensional parameter specified in degrees per 30 meters (e.g., or degrees per 100 feet).

As an example, a directional well can include several shapes where each of the shapes may aim to meet particular operational demands. As an example, a drilling process may be performed on the basis of information as and when it is relayed to a drilling engineer. As an example, inclination and/or direction may be modified based on information received during a drilling process.

As an example, deviation of a bore may be accomplished in part by use of a downhole motor and/or a turbine. As to a motor, for example, a drillstring can include a positive displacement motor (PDM).

As an example, a system may be a steerable system and include equipment to perform method such as geosteering. As mentioned, a steerable system can be or include an RSS. As an example, a steerable system can include a PDM or of a turbine on a lower part of a drillstring which, just above a drill bit, a bent sub can be mounted. As an example, above a PDM, MWD equipment that provides real time or near real time data of interest (e.g., inclination, direction, pressure, temperature, real weight on the drill bit, torque stress, etc.) and/or LWD equipment may be installed. As to the latter, LWD equipment can make it possible to send to the surface various types of data of interest, including for example, geological data (e.g., gamma ray log, resistivity, density and sonic logs, etc.).

The coupling of sensors providing information on the course of a well trajectory, in real time or near real time, with, for example, one or more logs characterizing the formations from a geological viewpoint, can allow for implementing a geosteering method. Such a method can include navigating a subsurface environment, for example, to follow a desired route to reach a desired target or targets.

As an example, a drillstring can include an azimuthal density neutron (ADN) tool for measuring density and porosity; a MWD tool for measuring inclination, azimuth and shocks; a compensated dual resistivity (CDR) tool for measuring resistivity and gamma ray related phenomena; a combinable magnetic resonance (CMR) tool for measuring properties (e.g., relaxation properties, etc.); one or more variable gauge stabilizers; one or more bend joints; and a geosteering tool, which may include a motor and optionally equipment for measuring and/or responding to one or more of inclination, resistivity and gamma ray related phenomena.

As an example, geosteering can include intentional directional control of a wellbore based on results of downhole geological logging measurements in a manner that aims to keep a directional wellbore within a desired region, zone (e.g., a pay zone), etc. As an example, geosteering may include directing a wellbore to keep the wellbore in a particular section of a reservoir, for example, to minimize gas and/or water breakthrough and, for example, to maximize economic production from a well that includes the wellbore.

Referring again to FIG. 2, the wellsite system 200 can include one or more sensors 264 that are operatively coupled to the control and/or data acquisition system 262. As an example, a sensor or sensors may be at surface locations. As an example, a sensor or sensors may be at downhole locations. As an example, a sensor or sensors may be at one or more remote locations that are not within a distance of the order of about one hundred meters from the wellsite system 200. As an example, a sensor or sensor may be at an offset wellsite where the wellsite system 200 and the offset wellsite are in a common field (e.g., oil and/or gas field).

As an example, one or more of the sensors 264 can be provided for tracking pipe, tracking movement of at least a portion of a drillstring, etc.

As an example, the system 200 can include one or more sensors 266 that can sense and/or transmit signals to a fluid conduit such as a drilling fluid conduit (e.g., a drilling mud conduit). For example, in the system 200, the one or more sensors 266 can be operatively coupled to portions of the standpipe 208 through which mud flows. As an example, a downhole tool can generate pulses that can travel through the mud and be sensed by one or more of the one or more sensors 266. In such an example, the downhole tool can include associated circuitry such as, for example, encoding circuitry that can encode signals, for example, to reduce demands as to transmission. As an example, circuitry at the surface may include decoding circuitry to decode encoded information transmitted at least in part via mud-pulse telemetry. As an example, circuitry at the surface may include encoder circuitry and/or decoder circuitry and circuitry downhole may include encoder circuitry and/or decoder circuitry. As an example, the system 200 can include a transmitter that can generate signals that can be transmitted downhole via mud (e.g., drilling fluid) as a transmission medium.

As mentioned, a drillstring can include various tools that may make measurements. As an example, a wireline tool or another type of tool may be utilized to make measurements. As an example, a tool may be configured to acquire electrical borehole images. As an example, the fullbore Formation MicroImager (FMI) tool (Schlumberger Limited, Houston, Tex.) can acquire borehole image data. A data acquisition sequence for such a tool can include running the tool into a borehole with acquisition pads closed, opening and pressing the pads against a wall of the borehole, delivering electrical current into the material defining the borehole while translating the tool in the borehole, and sensing current remotely, which is altered by interactions with the material.

Analysis of formation information may reveal features such as, for example, vugs, dissolution planes (e.g., dissolution along bedding planes), stress-related features, dip events, etc. As an example, a tool may acquire information that may help to characterize a reservoir, optionally a fractured reservoir where fractures may be natural and/or artificial (e.g., hydraulic fractures). As an example, information acquired by a tool or tools may be analyzed using a framework such as the TECHLOG framework. As an example, the TECHLOG framework can be interoperable with one or more other frameworks such as, for example, the PETREL framework.

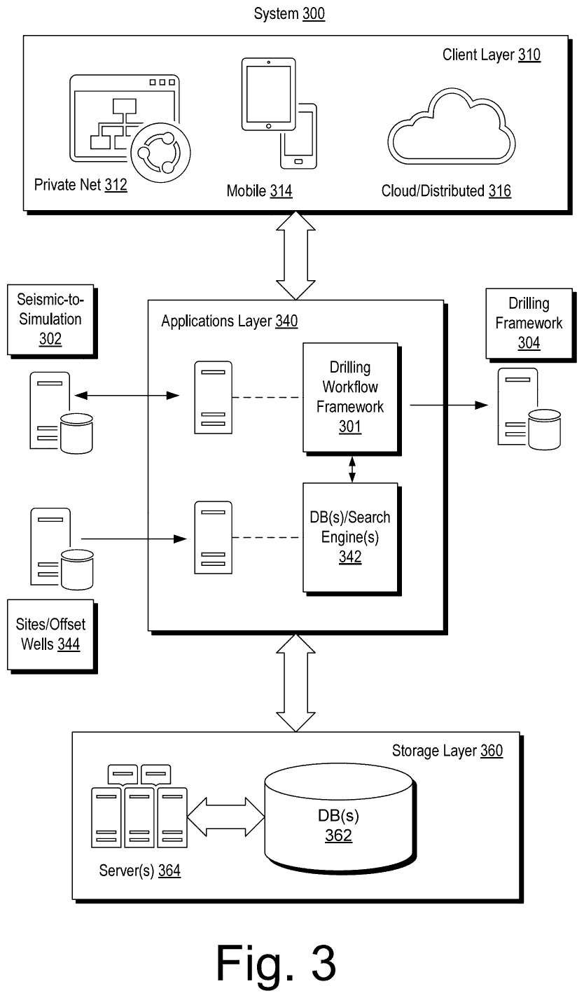

FIG. 3 shows an example of a data system 300 that includes a drilling workflow framework 301, a seismic-to-simulation framework 302, a drilling framework 304, a client layer 310, an applications layer 340 and a storage layer 360. As shown the client layer 310 can be in communication with the applications layer 340 and the applications layer 340 can be in communication with the storage layer 360. In such an example, a computational framework may be provided for handling of logging measurements and/or data derived from logging measurements. For example, logging information may be provided to the seismic-to-simulation framework 302 and/or to the drilling framework 304. Such information may be utilized for model building (e.g., constructing a multidimensional model of a geologic environment), generating a trajectory for a well (e.g., or an extension thereof), generating a stimulation plan (e.g., fracturing, chemical treatment, etc.), controlling one or more drilling operations, etc.

In the example of FIG. 3, the client layer 310 can include features that allow for access and interactions via one or more private networks 312, one or more mobile platforms and/or mobile networks 314 and via the “cloud” 316, which may be considered to include distributed equipment that forms a network such as a network of networks.

In the example of FIG. 3, the applications layer 340 includes the drilling workflow framework 301. The applications layer 340 also includes a database management component 342 that includes one or more search engine features (e.g., sets of executable instructions to perform various actions, etc.).

As an example, the database management component 342 can include one or more search engine features that provide for searching one or more information that may be stored in one or more data repositories. As an example, the STUDIO E&P knowledge environment (Schlumberger Ltd., Houston, Tex.) includes STUDIO FIND search functionality, which provides a search engine. The STUDIO FIND search functionality also provides for indexing content, for example, to create one or more indexes. As an example, search functionality may provide for access to public content, private content or both, which may exist in one or more databases, for example, optionally distributed and accessible via an intranet, the Internet or one or more other networks. As an example, a search engine may be configured to apply one or more filters from a set or sets of filters, for example, to enable users to filter out data that may not be of interest.

As an example, a framework may provide for interaction with a search engine and, for example, associated features such as features of the STUDIO FIND search functionality. As an example, a framework may provide for implementation of one or more spatial filters (e.g., based on an area viewed on a display, static data, etc.). As an example, a search may provide access to dynamic data (e.g., “live” data from one or more sources), which may be available via one or more networks (e.g., wired, wireless, etc.). As an example, one or more components may optionally be implemented within a framework or, for example, in a manner operatively coupled to a framework (e.g., as an add-on, a plug-in, etc.). As an example, a component for structuring search results (e.g., in a list, a hierarchical tree structure, etc.) may optionally be implemented within a framework or, for example, in a manner operatively coupled to a framework (e.g., as an add-on, a plug-in, etc.).

In the example of FIG. 3, the applications layer 340 can include communicating with one or more resources such as, for example, the seismic-to-simulation framework 302, the drilling framework 304 and/or one or more sites, which may be or include one or more offset wellsites. As an example, the applications layer 340 may be implemented for a particular wellsite where information can be processed as part of a workflow for operations such as, for example, operations performed, being performed and/or to be performed at the particular wellsite. As an example, an operation may involve directional drilling, for example, via geosteering. As an example, an operation may involve logging via one or more downhole tools.

In the example of FIG. 3, the storage layer 360 can include various types of data, information, etc., which may be stored in one or more databases 362. As an example, one or more servers 364 may provide for management, access, etc., to data, information, etc., stored in the one or more databases 362. As an example, the database management component 342 may provide for searching as to data, information, etc., stored in the one or more databases 362.

As an example, the database management component 342 may include features for indexing, etc. As an example, information may be indexed at least in part with respect to wellsite. For example, where the applications layer 340 is implemented to perform one or more workflows associated with a particular wellsite, data, information, etc., associated with that particular wellsite may be indexed based at least in part on the wellsite being an index parameter (e.g., a search parameter).

As an example, the data system 300 of FIG. 3 may be implemented to perform one or more portions of one or more workflows associated with the system 200 of FIG. 2. As an example, the drilling workflow framework 301 may interact with a technical data framework (e.g., a logging data framework, etc.) and the drilling framework 304 before, during and/or after performance of one or more drilling operations. In such an example, the one or more drilling operations may be performed in a geologic environment (see, e.g., the environment 150 of FIG. 1) using one or more types of equipment (see, e.g., equipment of FIGS. 1 and 2).

As an example, an architecture utilized in a system such as, for example, the data system 300 may include features of the AZURE architecture (Microsoft Corporation, Redmond, Wash.). As an example, a cloud portal block can include one or more features of an AZURE portal that can manage, mediate, etc. access to one or more services, data, connections, networks, devices, etc. As an example, the system 300 may include features of the GOOGLE cloud architecture (Google, Mountain View, Calif.).

As an example, the system 300 can include a cloud computing platform and infrastructure, for example, for building, deploying, and managing applications and services (e.g., through a network of datacenters, etc.). As an example, such a cloud platform may provide PaaS and IaaS services and support one or more different programming languages, tools and frameworks, etc.

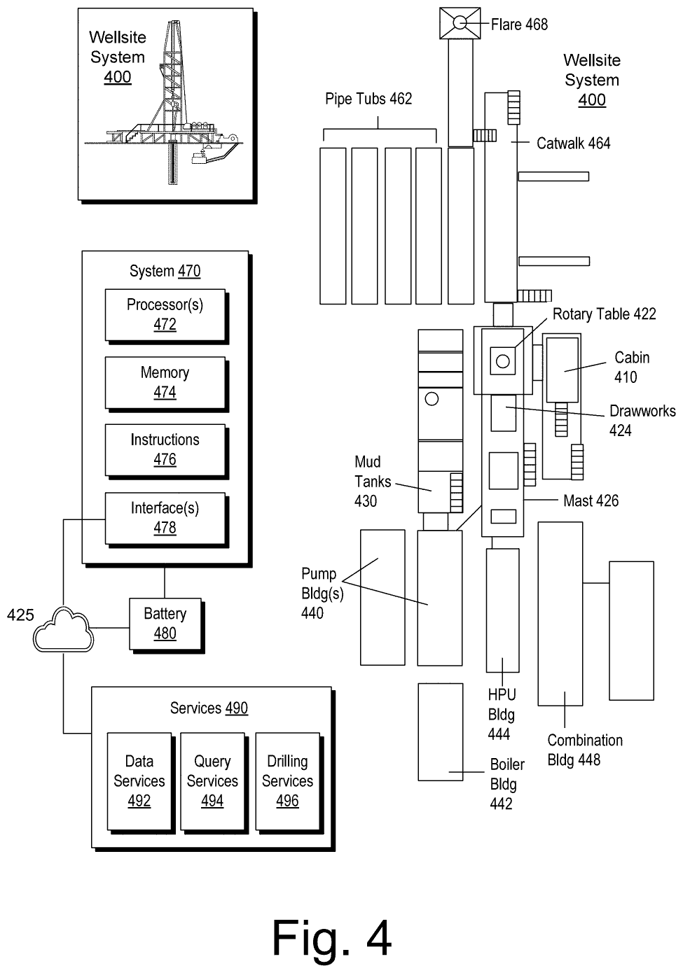

FIG. 4 shows an example of a wellsite system 400, specifically, FIG. 4 shows the wellsite system 400 in an approximate side view and an approximate plan view along with a block diagram of a system 470.

In the example of FIG. 4, the wellsite system 400 can include a cabin 410, a rotary table 422, drawworks 424, a mast 426 (e.g., optionally carrying a top drive, etc.), mud tanks 430 (e.g., with one or more pumps, one or more shakers, etc.), one or more pump buildings 440, a boiler building 442, a hydraulic pumping units (HPU) building 444 (e.g., with a rig fuel tank, etc.), a combination building 448 (e.g., with one or more generators, etc.), pipe tubs 462, a catwalk 464, a flare 468, etc. Such equipment can include one or more associated functions and/or one or more associated operational risks, which may be risks as to time, resources, and/or humans.

A wellsite can include a prime mover as a source of power. As an example, a prime mover can include one to four or more diesel engines, which may produce several thousand horsepower. Such engines can be operatively coupled to one or more electric generators. Electrical power may be distributed by a silicon-controlled-rectifier (SCR) system. Rigs that convert diesel power to electricity may be referred to as electric rigs or diesel electric rigs. As an example, a rig can be configured for transmission of power from one or more diesel engines to one or more rig components (e.g., drawworks, pumps, rotary table, etc.) through mechanical belts, chains, clutches, etc. Such a configuration may be referred to a mechanical rig or a so-called “power rig”.

As shown in the example of FIG. 4, the wellsite system 400 can include a system 470 that includes one or more processors 472, memory 474 operatively coupled to at least one of the one or more processors 472, instructions 476 that can be, for example, stored in the memory 474, and one or more interfaces 478. As an example, the system 470 can include one or more processor-readable media that include processor-executable instructions executable by at least one of the one or more processors 472 to cause the system 470 to control one or more aspects of the wellsite system 400. In such an example, the memory 474 can be or include the one or more processor-readable media where the processor-executable instructions can be or include instructions. As an example, a processor-readable medium can be a computer-readable storage medium that is not a signal and that is not a carrier wave.

FIG. 4 also shows a battery 480 that may be operatively coupled to the system 470, for example, to power the system 470. As an example, the battery 480 may be a back-up battery that operates when another power supply is unavailable for powering the system 470. As an example, the battery 480 may be operatively coupled to a network 425, which may be a cloud network. As an example, the battery 480 can include smart battery circuitry and may be operatively coupled to one or more pieces of equipment via a system management bus (SMBus) or other type of bus.

In the example of FIG. 4, services 490 are shown as being available, for example, via a cloud platform. Such services can include data services 492, query services 494 and drilling services 496. As an example, the services 490 may be part of a system such as the system 300 of FIG. 3.

As an example, a system such as, for example, the system 300 of FIG. 3 may be utilized to perform a workflow. Such a system may be distributed and allow for collaborative workflow interactions and may be considered to be a platform (e.g., a framework for collaborative interactions, etc.).

As an example, a workflow can commence with an evaluation stage, which may include a geological service provider evaluating a formation. As an example, a geological service provider may undertake the formation evaluation using a computing system executing a software package tailored to such activity; or, for example, one or more other suitable geology platforms may be employed (e.g., alternatively or additionally). As an example, the geological service provider may evaluate the formation, for example, using earth models, geophysical models, basin models, petrotechnical models, combinations thereof, and/or the like. Such models may take into consideration a variety of different inputs, including offset well data, seismic data, pilot well data, other geologic data, etc. The models and/or the input may be stored in the database maintained by the server and accessed by the geological service provider.

As an example, a workflow may progress to a geology and geophysics (“G&G”) service provider, which may generate a well trajectory, which may involve execution of one or more G&G software packages. Examples of such software packages include the PETREL framework. As an example, a system or systems may utilize a framework such as the DELFI framework (Schlumberger Limited, Houston, Tex.). Such a framework may operatively couple various other frameworks to provide for a multi-framework workspace.

As an example, a G&G service provider may determine a well trajectory or a section thereof, based on, for example, one or more model(s) provided by a formation evaluation, and/or other data, e.g., as accessed from one or more databases (e.g., maintained by one or more servers, etc.). As an example, a well trajectory may take into consideration various “basis of design” (BOD) constraints, such as general surface location, target (e.g., reservoir) location, and the like. As an example, a trajectory may incorporate information about tools, bottom-hole assemblies, casing sizes, etc., that may be used in drilling the well. A well trajectory determination may take into consideration a variety of other parameters, including risk tolerances, fluid weights and/or plans, bottom-hole pressures, drilling time, etc.

Well planning can include determining a path of a well that can extend to a reservoir, for example, to economically produce fluids such as hydrocarbons therefrom. Well planning can include selecting a drilling and/or completion assembly which may be used to implement a well plan. As an example, various constraints can be imposed as part of well planning that can impact design of a well. As an example, such constraints may be imposed based at least in part on information as to known geology of a subterranean domain, presence of one or more other wells (e.g., actual and/or planned, etc.) in an area (e.g., consider collision avoidance), etc. As an example, one or more constraints may be imposed based at least in part on characteristics of one or more tools, components, etc. As an example, one or more constraints may be based at least in part on factors associated with drilling time and/or risk tolerance.

As an example, drilling can occur in sections where a cementing operation may be performed after drilling one section and before drilling another section. A shoe track or float joint can be a length of casing placed at a bottom of a casing string that may be left full of cement in an inside space to ensure that suitable cement remains on an outside space of the bottom of the casing. If cement were not left inside the casing, a risk of over-displacing the cement (e.g., due to improper casing volume calculations, displacement mud volume measurements, etc.) can increase. A well plan can include a safety margin of cement left inside a casing to help assure that the fluid left in a space outside the casing is of acceptable quality cement. As an example, a float collar can be placed at a top of a float joint and a float shoe placed at a bottom to hinder reverse flow of cement back into the casing after placement. As an example, there may be one or more joints of casing used in such operations.

As explained, a shoe track can be a space between a casing shoe and an uppermost collar. A shoe track can help to accommodate contaminated cement and prevent it from filling the space around a casing shoe and an annulus. As an example, a float collar can be placed above a shoe track to provide a seat for one or more wiper plugs that may be used during one or more cementing operations. A float shoe with a non-return valve may be positioned at the bottom to hinder reverse flow of cement slurry back into the casing after placement.

As mentioned, a borehole may be drilled in sections where one or more cementing operations occur after one section is drilled and before another section is drilled. Where a shoe track is created, it can be drilled out before drilling a new section.

Drilling of a shoe track (e.g., and associated material, equipment, etc.) can be a challenging task and result in one or more issues. Such issues may lead to a substantial amount of non-productive time (NPT), lingering issues due to debris, damage to one or more components, a decrease in integrity of a portion or portions of a completed well, etc. Drilling of a shoe track may cause undesirable wear or damage to a bit, which may result in suboptimal drilling and, for example, tripping out, bit repair or replacement and tripping in.

A shoe track drill out study can be an internal analysis performed within a service company or by an operator. By trying different bit configurations and drilling parameters, drill bit and float equipment suppliers seek the optimal means of shoe track drilling. As an example, a drill out may be performed with a rotary steerable tool that may include one or more LWD assemblies. As an example, a drill out may or may not be a dedicated run. For example, a drill out may be for drilling out one or more materials as associated with a shoe track, etc., and then for new formation drilling (e.g., to deepen a borehole).

Drilling through a shoe track and adjacent float equipment (e.g., a float collar and a shoe) may take a number of hours (e.g., consider from 2 hours to 14 hours or more). A relatively efficient drill out may be less than 5 hours; whereas, an inefficient drill out may be more than 10 hours. While efficiency may be measured with respect to time, as mentioned, a drill out may aim to minimize one or more other concerns (e.g., debris, damage, etc.). An article by Wiktorski et al., entitled “Shoe track drill out analysis: factors affecting drilling efficiency”, SPE-18001-MS (20 Apr. 2016) is incorporated by reference herein. Factors noted include variation of ROP with respect to operational parameters of WOB and RPM. A mathematical model of ROP=Constant+a*WOB+b*RPM+c*Torque was utilized where the coefficients a, b and c were parameters to be fit using field data, which provided a correlation (R²) of 0.84. Another model, Bourgoyne and Young, was utilized in Wiktorski et al., which included pore pressure, bit weight, sediments compaction, jet impact force, ROM, bit hydraulics and bit cutters wear. Wiktorski et al., provide information for PDC and Roller Cone drill outs for plugs/landing collar and float collar/cement/shoe and for wiper plug and collar, collar without plugs, cement, and shoe. Issues that may arise during drill outs include jammed bits and rotating plugs. Such issues may result in delays (e.g., NPT).

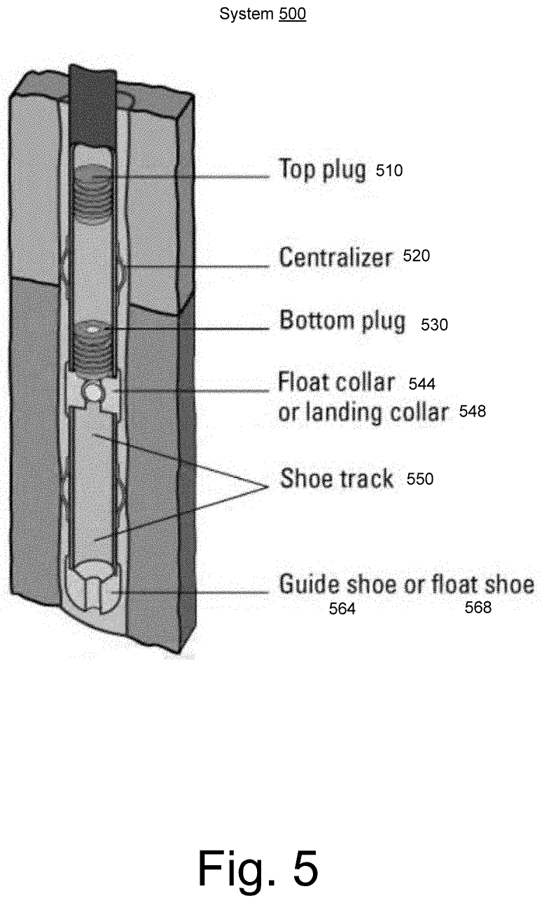

FIG. 5 shows an example of a cemented system 500 that includes a borehole in a geologic environment where the system 500 includes a top plug 510, a centralizer 520, a bottom plug 530, a float collar 544 or a landing collar 548, a shoe track 550 and a guide shoe 564 or a float shoe 568. As shown in the example of FIG. 5, the shoe track 550 is disposed between components.

As an example, float equipment used to cement a casing can include a sub-surface released cementing plug with float collar and a float shoe. As an example, a plug system can include various components such as a double dart plug container, a swivel equalizer, non-rotating sub-surface plugs with drillpipe wiper darts, and a non-rotating float collar. As an example, float equipment can include a plug with fins where fins may be made of a polymeric material (e.g., polyurethane, etc.), where an inner part may be made of a duromer and a poppet valve made of plastic. As an example, internal parts of a float collar may be made from concrete and one or more phenolic materials.

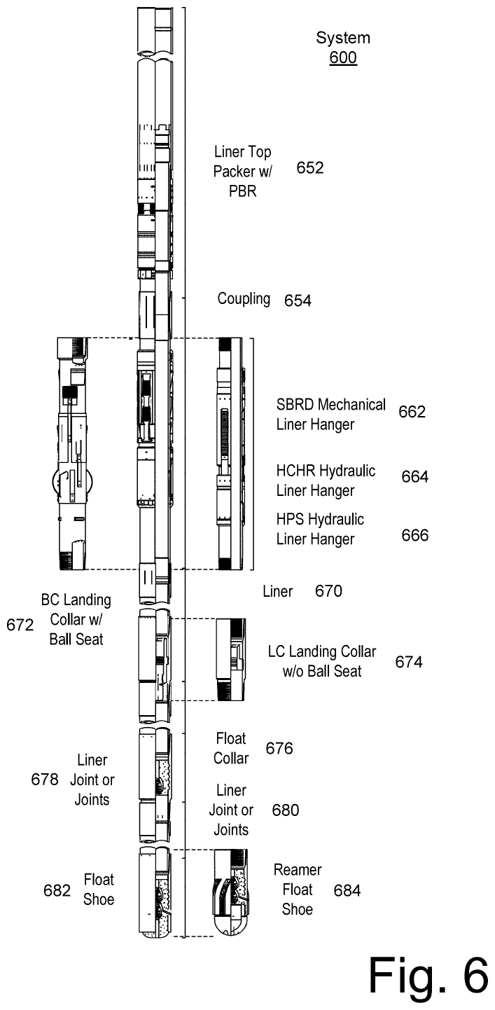

FIG. 6 shows an example of a liner system 600 where the system 600 can include a liner top packer with a polished bore receptacle (PBR) 652, a coupling(s) 654, a mechanical liner hanger 662, a hydraulic liner hanger 664, a hydraulic liner hanger 666, a liner(s) 670, a landing collar with a ball seat 672, a landing collar without a ball seat 274, a float collar 676, a liner joint or joints 678 and/or 680, a float shoe 682 and/or a reamer float shoe 684.

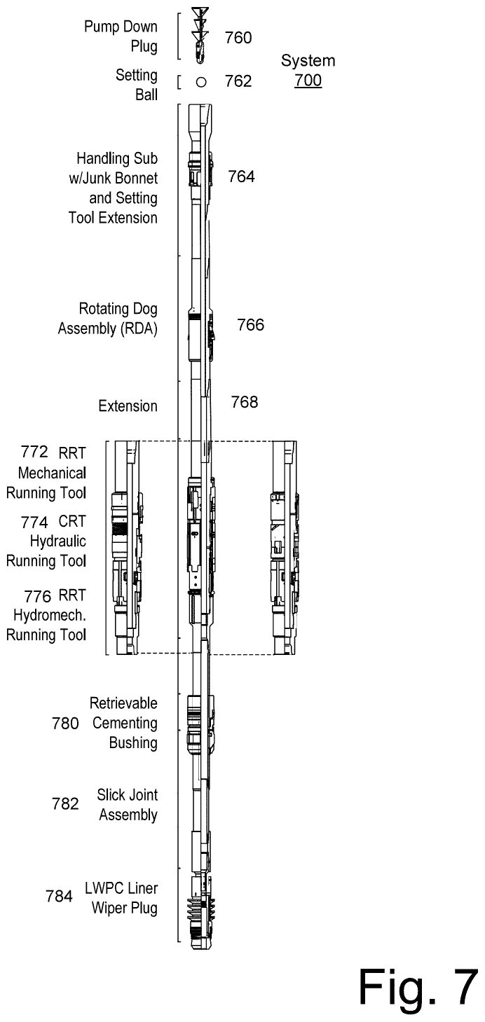

FIG. 7 shows an example of a system 700 that can include a pump down plug 760, a setting ball 762, a handling sub with a junk bonnet and setting tool extension 764, a rotating dog assembly (RDA) 766, an extension(s) 768, a mechanical running tool 772, a hydraulic running tool 774, a hydromechanical running tool 776, a retrievable cementing bushing 780, a slick joint assembly 782 and/or a liner wiper plug 784.

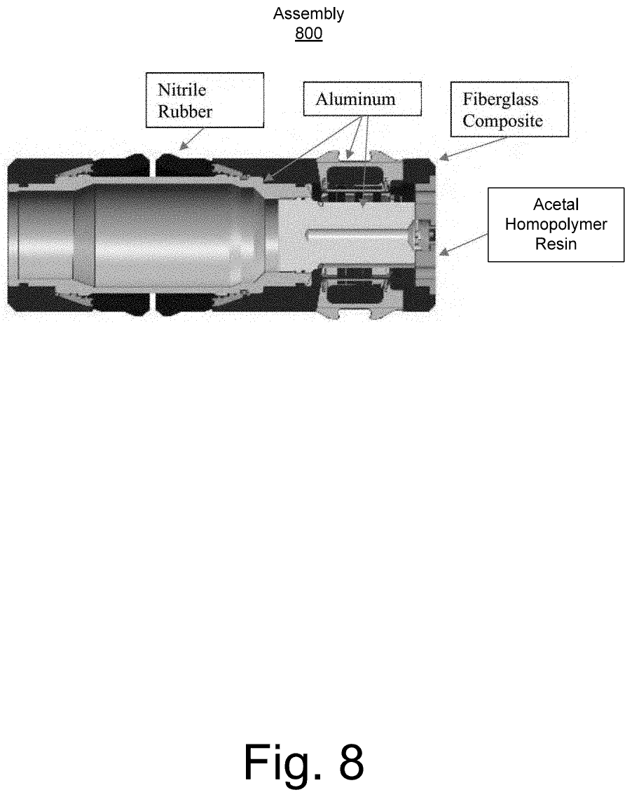

FIG. 8 shows an example of a pump down displacement plug (PDDP) assembly 800. As shown, the assembly 800 includes various components that can be made of various types of materials. For example, consider nitrile rubber wiper assembly, aluminum conduit and latches, fiberglass composite material of a housing for the PDDP, and acetal homopolymer resin. A drill out operation can be performed that aims to drill into one or more of the components of the assembly 800. As the types of materials, shapes of components, etc., can differ, the environment being drilled is heterogeneous and can present some challenges for drilling equipment, completions, residue (e.g., residual material such as cuttings), etc.

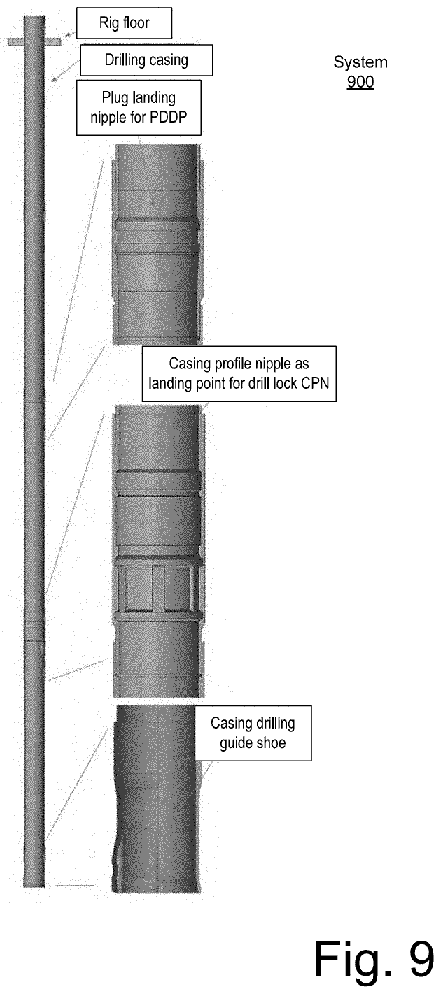

FIG. 9 shows an example of a system 900 with various components, assemblies, etc. For example, consider a rig floor that represents a surface location from which drilling casing can extend downwardly into a geologic environment (e.g., hundreds of meters to thousands of meters or more) where a plug landing nipple (PLN) for a PDDP is present, where a casing profile nipple (CPN) is present as a landing point for a drill lock CPN, and where a casing drilling shoe guide is also present.

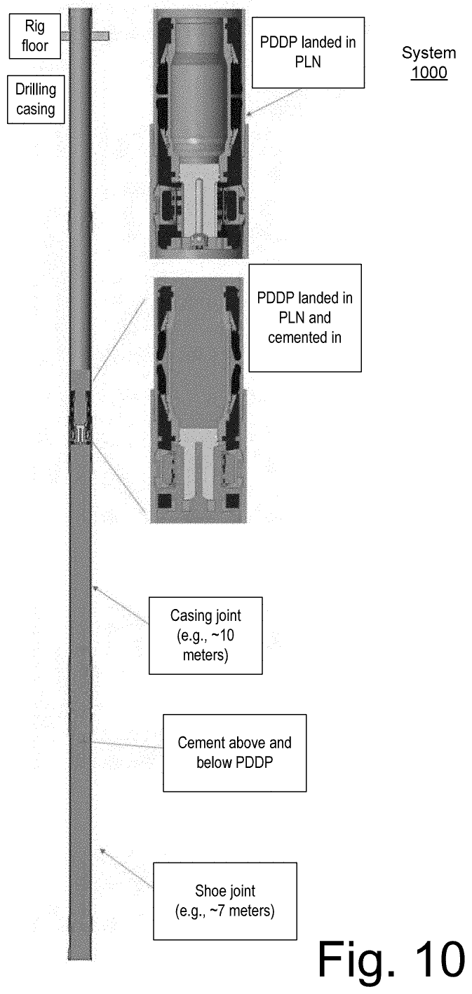

FIG. 10 shows an example of a cemented casing string system 1000 with reference to the rig floor and drilling casing (see, e.g., FIG. 9) with a PDDP landed in a PLN where the PDDP can be cemented in (e.g., at least partially filled with cement), a casing joint (e.g., approximately 10 meters in length), an extent of cement that extends above the PDDP and below the PDDP in the example of FIG. 10, and a shoe joint (e.g., approximately 7 meters in length).

FIGS. 5 to 10 show various types of equipment, materials, etc., that can be in a downhole environment. As mentioned, drilling equipment may be utilized to drill through man-made materials or other materials shown in these figures described above that may be placed downhole via one or more drilling related operations. Such drilling, which may be referred to as drilling out or drill out (or drillout), can present challenges, which may differ in one or more aspects from drilling into natural materials (e.g., rock, etc.).

As an example, a method can include drilling optimization of plug drill out and shoe track drill out using one or more machine learning models that can generate one or more trained machine learning models (ML models).

As an example, consider a wiper plug that is to be drilled out. The composition of wiper plugs can vary substantially. As an example, a ML model can be trained to account for variations in composition of a wiper plug or wiper plugs. Such a trained ML model may be utilized to provide output that can automatically be utilized and/or manually be utilized for performing a drill out task.

As an example, a trained ML model can output guidance that is based on historical data from one or more previous drill outs of one or more wiper plugs. In such an example, a machine learning system can identify current drilling parameters and rate of penetration (ROP) and output optimal or more optimal parameters based on the learned information from one or more previous drill outs.

As an example, a ML model system can identify and analyze one or more drilling jobs and output optimal or more optimal parameters in real time for drilling based on identified real time activity.

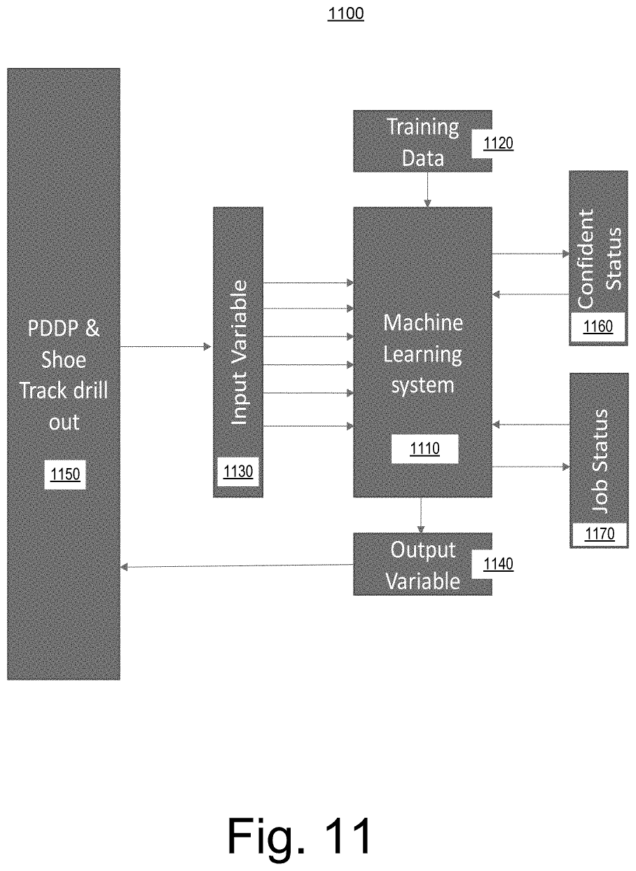

FIG. 11 shows an example of a system 1100 that includes a machine learning system 1110 that can be trained using training data 1120 such that one or more trained ML models can be utilized to receive input variables 1130 to generate one or more output variables 1140. As an example, a single metric approach may be utilized as an output variable to indicate a status (e.g., state, etc.) of a drilling operation (e.g., a drill out operation). In the example of FIG. 11, a PDDP and shoe track drill out component 1150 is shown that can be instrumented to provide information as input variables (see the input variables 1130) to the machine learning system 1110 such that at least one output variable can be returned (see the output variable 1140). In such an example, real time information is received by one or more ML models and real time information is output to inform a real time drill out operation. As shown, the system 1100 can include a confidence status component 1160 and/or a job status component 1170.

As an example, a ML model can be a “deep learning” ML model. Deep learning (e.g., deep structured learning or hierarchical learning) is part of a broader family of machine learning methods that can utilize artificial neural networks (ANNs). As an example, learning can be supervised, semi-supervised or unsupervised. A deep learning (DL) architecture (e.g., deep neural networks, deep belief networks, recurrent neural networks, convolutional neural networks, etc.) may be utilized for generating a ML model or ML models suitable for use in drill out operations.

As an example, the TENSORFLOW framework (Google LLC, Mountain View, Calif.) may be implemented, which is an open source software library for dataflow programming that includes a symbolic math library, which can be implemented for machine learning applications that can include neural networks. As an example, the CAFFE framework may be implemented, which is a DL framework developed by Berkeley AI Research (BAIR) (University of California, Berkeley, Calif.). As another example, consider the SCIKIT platform (e.g., scikit-learn), which utilizes the PYTHON programming language. As an example, a framework such as the APOLLO AI framework may be utilized (APOLLO.AI GmbH, Germany).

As an example, a training method can include various actions that can operate on a dataset to train a ML model. As an example, a dataset can be split into training data and test data where test data can provide for evaluation. A method can include cross-validation of parameters and best parameters, which can be provided for model training.

The TENSORFLOW framework can run on multiple CPUs and GPUs (with optional CUDA (NVIDIA Corp., Santa Clara, Calif.) and SYCL (The Khronos Group Inc., Beaverton, Oreg.) extensions for general-purpose computing on graphics processing units (GPUs)). TENSORFLOW is available on 64-bit LINUX, MACOS (Apple Inc., Cupertino, Calif.), WINDOWS (Microsoft Corp., Redmond, Wash.), and mobile computing platforms including ANDROID (Google LLC, Mountain View, Calif.) and IOS (Apple Inc.) operating system based platforms.

TENSORFLOW computations can be expressed as stateful dataflow graphs; noting that the name TENSORFLOW derives from the operations that such neural networks perform on multidimensional data arrays. Such arrays can be referred to as “tensors”.

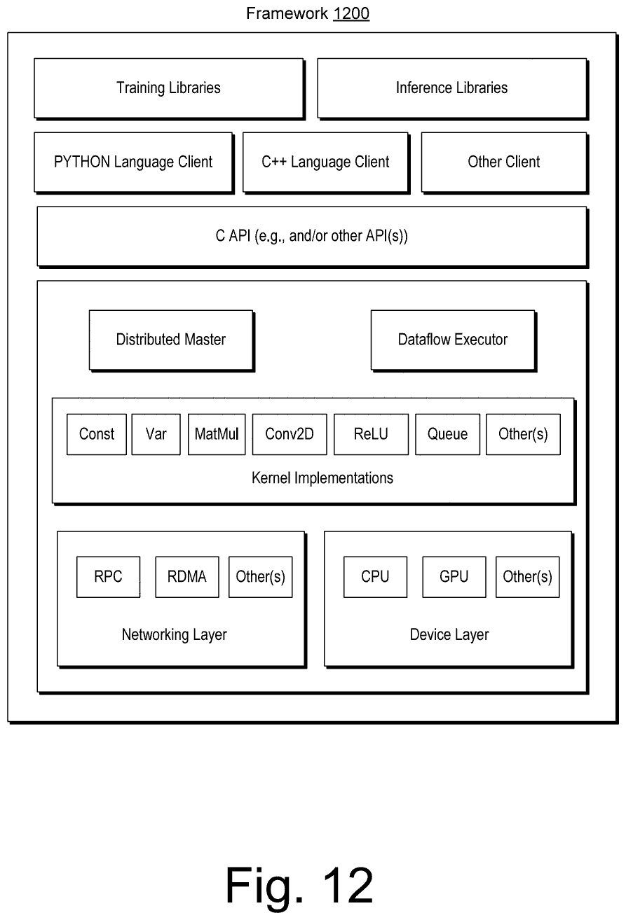

FIG. 12 shows an architecture 1200 of a framework such as the TENSORFLOW framework. As shown, the architecture 1200 includes various features. As an example, in the terminology of the architecture 1200, a client can define a computation as a dataflow graph and, for example, can initiate graph execution using a session. As an example, a distributed master can prune a specific subgraph from the graph, as defined by the arguments to “Session.run( )”; partition the subgraph into multiple pieces that run in different processes and devices; distributes the graph pieces to worker services; and initiate graph piece execution by worker services. As to worker services (e.g., one per task), as an example, they may schedule the execution of graph operations using kernel implementations appropriate to hardware available (CPUs, GPUs, etc.) and, for example, send and receive operation results to and from other worker services. As to kernel implementations, these may, for example, perform computations for individual graph operations.

As explained, drill outs can present challenges that may not be present in formation drilling. Drill outs can involve complex and rapidly changing conditions of drilling through various types of components, materials, etc. An approach to formation drilling may involve using a formation drilling system that estimates formation “strength” and gives appropriate recommendations based on constraints such as equipment limits, hole cleaning limits, etc., as well as recommendations to mitigate stick slip, shock and vibrations, and hard stringers. Such a system does not account for conditions associated with drill outs (e.g., shoe tracks, etc.). As an example, a formation drilling system may be augmented to include a system or portions thereof as in the system 1100 of FIG. 11. In such an augmented system, guidance can be provided for formation drilling and drill outs, which can facilitate operations, for example, where formation drilling is to follow a drill out.

As shown in FIG. 8 and FIG. 10, a PDDP (e.g., a wiper plug) can be a type of assembly that is to be utilized in an operation (e.g., cementing) and that is to be later drilled out such that a borehole can be deepened. As mentioned, an assembly can be made from several elements that offer different drilling challenges. Rules of drilling a plug can change as the drilling progresses, partly from a change in geometry, partly from a change in material and partly from a change resulting from debris created while drilling though the parts above a current bit location.

The system 1100 of FIG. 11 can be considered an artificial intelligence (AI) approach to drill outs. Such a system can be configured to automatically detect poor drill outs in real time and recommend changes for improved performance. As an example, a ML model can adjust recommendations by detecting real time drilling parameters and/or vibration levels as a feedback to make it a closed loop system.

As an example, an ML model can utilize unsupervised learning to find hidden patterns in training data from previous field jobs by classifying the previous jobs, for example, into “good” or “bad” runs.

As an example, in an initial phase, a process may include an expert (engineer on rig), while the system learns. Based on this learning, the ML model provides prescriptive analytics and recommends changes to lead to a “good” run.

As an example, a system may include one or more levels of automation, for example, to reduce reliance on an expert field engineer. As mentioned, there may be an integration with one or more formation drilling frameworks (e.g., planning, operational drilling, etc.).

As an example, a ML model can be trained using various types of equipment, which may optionally result in one or more different ML models. For example, consider a PDDP ML model, which may be for a particular type of PDDP. As an example, one or more ML models can be trained to provide guidance for drilling through various types of equipment, materials, etc. (e.g., plugs, landing collars, float equipment, etc.).

A U.S. Pat. No. 8,799,198 B2 is incorporated by reference herein ('198 patent), which describes a method of optimizing a drilling operating parameter or a drilling system parameter for a drilling assembly employing at least first and second distinct cutting structures includes entering at least one design parameter for each of the cutting structures into a trained artificial neural network where at least one of the design parameters of the first cutting structure may be optionally combined with at least one of the design parameters of the second cutting structure and where the combined design parameter may also be entered into the artificial neural network. The '198 patent states that the cutting area of the first cutting structure may be combined with a cutting area of the second cutting structure to obtain a combined cutting area (e.g., a ratio, an average, or a weighted ratio or average) where the combined design parameter may be further processed in combination with a drilling operating parameter to obtain a combined drilling operating parameter. For example, a total WOB (e.g., as measured at the surface) may be divided between the first and second cutting structures such that the first the cutting structure bears a first portion of the total weight and the second cutting structure bears a second portion of the total weight. The weight borne by each of the cutting structures may be computed, for example, based on a ratio of the cutting areas (or cutting diameters) of the first and second cutting structures. Thus, for example, if the first cutting structure has a larger area than the second cutting structure, it may be determined to bear a larger proportion of the total WOB. Determination of the weight on each of the cutting structures may further take into account other factors such as the formation type in which each of the cutting structures is deployed. For example, when the first and second cutting structures are deployed in corresponding formations having the same or similar properties (e.g., the compressive strength of the rock), the weights may be determined using a simple area ratio. However, when the first and second cutting structures are deployed in corresponding formations having different properties, the weights may be determined using additional factors (e.g., a weighted area ratio or via a ratio or weighted ratio of the compressive strengths of the corresponding formations). The '198 patent also states that a cutting structure deployed in a soft formation such as sandstone tends to bear a smaller proportion of the total weight than a cutting structure deployed in a hard formation such as a salt or shale.

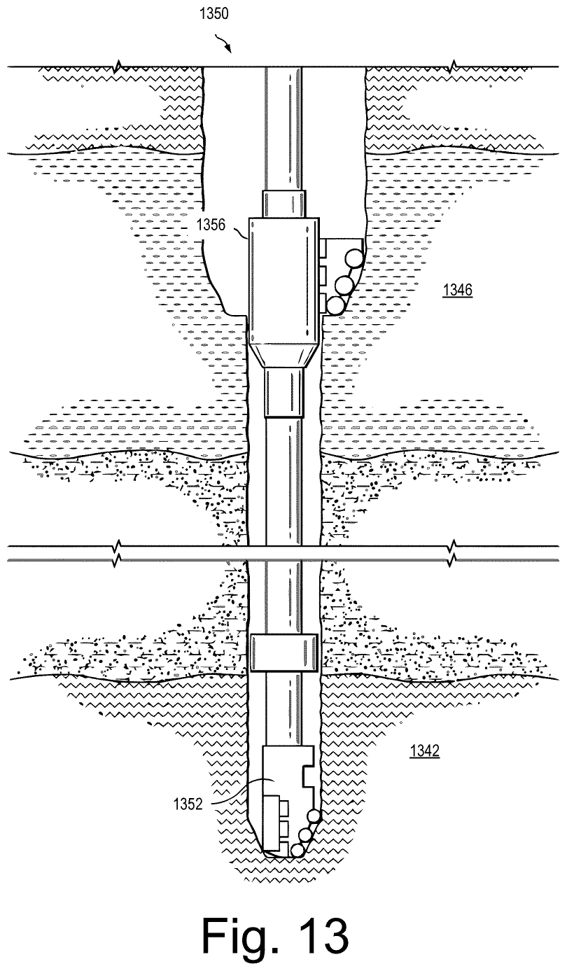

FIG. 13 depicts a portion of a BHA 1350. The BHA 1350 includes a first cutting structure, e.g., a drill bit 1352, deployed at a lower end of the drill string 1330. The drill bit 1352 may include substantially any type of drill bit suitable for subterranean drilling operations, for example including a fixed-cutter (or fixed-head) bit, a roller cone bit, or a percussion bit (e.g., fixed-cutter bits (commonly referred to as PDC bits) can include a cutting head having a plurality of ribs (or blades) arranged about a rotational axis of the bit). Cutting elements (e.g., polycrystalline diamond compacts—PDC) may be deployed in the ribs and are disposed to engage the formation as the bit is rotated. Roller cone bits can include a plurality of roller cones mounted on corresponding journals. The roller cones are disposed to rotate with respect to a bit body and include cutting elements deployed in the surface of the cones. Rotation of the bit causes a corresponding rotation of the cones, which in turn causes the cutting elements to engage the formation. In percussion or hammer drilling operations, the drill bit simultaneously rotates and impacts the earth in a cyclic fashion to crush, break, and loosen formation material. In such operations, the mechanism for penetrating the formation tends to be of an impact nature, rather than shearing. The percussion bit body typically includes a lower cutting face having a plurality of cutting elements that extend downward from the cutting face. These elements are disposed to engage and break up the formation upon impact. One or more drill bit configurations may be utilized and training data may include data for one or more drill bit configurations.

FIG. 13 further depicts a second cutting structure 1356, for example, a hole opener or underreamer deployed above the drill bit 1352 in BHA 1350. Hole openers and underreamers can be utilized during drilling in borehole enlargement operations. A hole opener can be a cutting structure having fixed cutting blades and an underreamer can be a cutting structure having extendable and retractable cutting blades.

In FIG. 13, the second cutting structure may include substantially suitable hole opener or underreamer configuration for increasing the diameter of the borehole. For example, the second cutting structure 1356 may include a hole opener of the insert cutter, fixed cutter, tooth cutter, or roller cone cutter type. The second cutting structure 1356 may also include an underreamer such as a drilling-type or wing (blade) type underreamer. Drilling type underreamers may include multiple hinged arms with roller cone cutters attached thereto. The extendable and retractable cutting arms may be mechanically and/or hydraulically actuated and may be configured to swing out on a pivot from a recess in the tool body into cutting engagement with the borehole wall. Winged underreamers may include at least one longitudinally extending wing or blade that projects radially outwardly from the tool body. The blades can include cutting elements and may be fixed to the tool body or may be configured to be extendable outward from the tool body.

As explained, rather than formation drilling, a machine learning system can provide guidance for drill outs. For example, consider addressing a problem of detection from PDDP and shoe track drill out. As explained with respect to FIG. 11, one or more drilling parameter variables can be entered into a ML system which has been trained from history of the operation to determine job status and confidence level status. A ML system can include capabilities to provide prescriptive analytics that aim to improve possibility to finish a drill out efficiently. The output from a ML system may be sent to a rigsite as recommended drilling parameter(s). As an example, one or more drilling parameters may be monitored and analyzed and an output variable (or output variables) updated, which may be based in part on current job status and/or confidence status.

As an example, data/signal flow of a ML system may be configured as in a closed loop system, which is trained from history of operation(s) to determine job status and confidence level status. As an example, machine learning may be performed in an unsupervised learning manner.

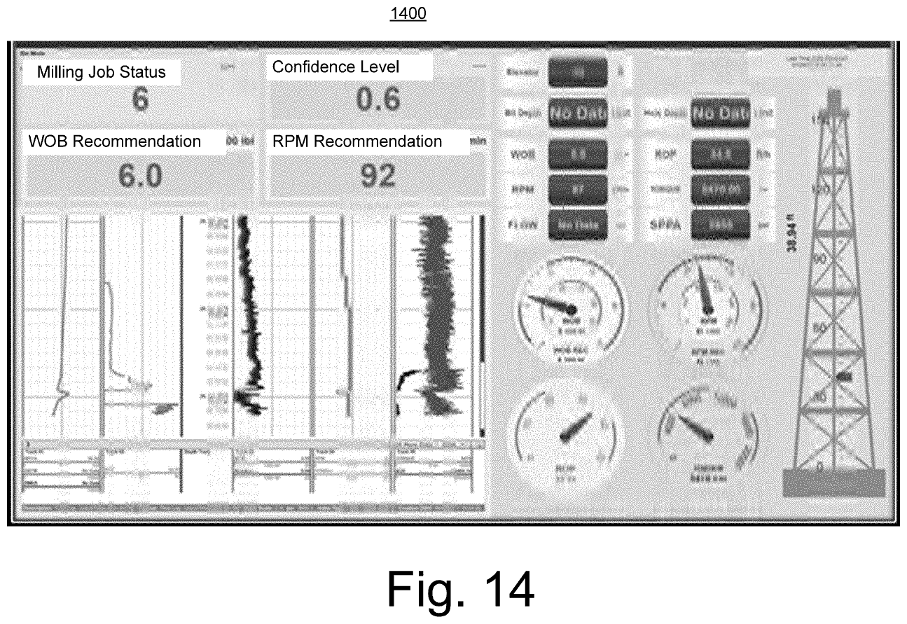

FIG. 14 shows an example of a graphical user interface (GUI) 1400 that pertains to a drill out, referred to as a milling job. The GUI 1400 can be operatively coupled to a trained ML model (e.g., local and/or remote) and be operatively coupled to equipment at a rigsite (e.g., local and/or remote). The GUI 1400 can output information by rendering numbers, graphics, etc., to a display that can provide guidance as to a drill out operation.

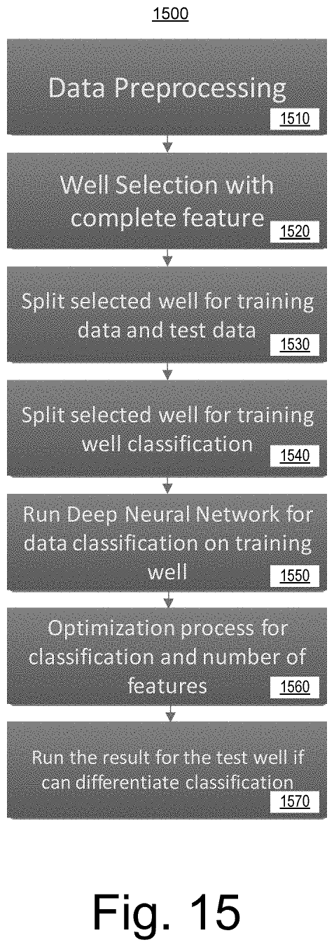

FIG. 15 shows an example of a ML training method 1500 that includes a data preprocessing block 1510, a well selection with complete feature block 1520 (e.g., one or more completion features, etc.), a split block 1530 for splitting selected well for training data and test data, a split block 1540 for splitting a selected well for training well classification, a train block 1550 for running a deep neural network for data classification on training data, an optimization block 1560 for optimizing a process for classification number of features, and a run block 1570 for running the result for a test well to see if it can differentiate classification.

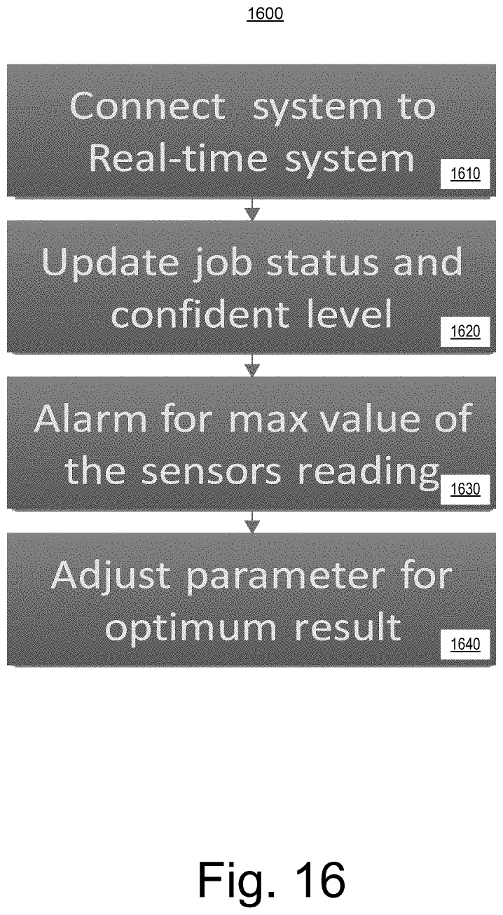

FIG. 16 shows an example of a method 1600 that includes a connection block 1610 for connecting a ML system to a real time system, an update block 1620 for updating a job status and confidence level, an issuance block 1630 for issuing an alarm (e.g., notification) for maximum value of sensor reading(s), and an adjust block 1640 for adjusting an operational drill out parameter(s) for a recommended optimal result.

As an example, a process can involve a well with minimum data features which will be used for an ML model based approach to drill out. Where a well does not provide sufficient inputs/matched inputs, a notification may be issued that another approach is to be taken. As an example, for training data and/or test data, such criteria may be applied as data are to provide sufficient information to train an ML model of an ML system. Where features available (e.g., information, etc.) are in excess, data may be filtered and/or trimmed appropriately. A method can include select a group of well with a relatively consistent number of features. As an example, a number of features can depend on complexity of a drill out problem to be addressed. A method may include sensitivity and/or other analysis to arrive at a particular set of features to address a particular drill out problem.

As mentioned, a method can include data preprocessing. For example, data may be processed to precondition the data, removing data gap, noise removal, and data sampling. As an example, wells involved can have another filter, which includes data coverage of an event, where a sensor(s) is calibrated properly, following drilling procedure (e.g., standard operating procedure “SOP”) and depth setup. As an example, a well that does not pass a minimum level of specifications may be excluded (e.g., data therefrom excluded from training and/or test data).

As an example, a selected well can be split, as appropriately, into good run and bad run (e.g., in terms of hours, efficiency, debris, damage, etc.), and later on both categories can be utilized for a training well and a test well.

As mentioned, a ML system may utilize deep learning (DL) as in a deep neural network model (DNN model). As an example, training well data can be processed using a DNN model for classification, which can be used to determine well categories, etc. A number of features and classifications may be optimized, for example, by study of component analysis.

As an example, a result of the training (e.g., a trained DNN model) can be used on a test well if the well categories match. Such a process can continue, as this can involve an optimization process, where the ML system has the capabilities to pursue a better result. As an example, data from a single well may be split into training data and test data or, for example, a single well may provide training data and another, different single well may provide test data. While single wells may be mentioned, training data can be from a group of wells and test data can be from a group of wells.

After training and testing, a ML system can be connected to a real time drilling system (see, e.g., FIG. 1, FIG. 2, FIG. 3, FIG. 4, etc.). As mentioned, a ML system can be implemented as appropriate to help to drill out a PDDP efficiently, which can involve saving bit life for better performance in drilling formation and/or steerability for directional drilling. As mentioned, a ML system may provide guidance for drill outs and formation drilling.

As an example, a ML system can include a GUI suitable for rendering a rig floor screen, which includes information for a process to optimize a run and also, for example, an alarm system, in case there is a drilling parameter that exceeds a limit.

After connection the ML system can receive a data stream which will be processed to recognize job categories and, for example, confident level. As mentioned, an alarm system can also monitor drilling parameters. As an example, a driller can respond to make a ML system to be on specific job category and to increase confident level by changing a drilling parameter. The ML system itself can, for example, monitor the response of a driller and implement one or more changes that the driller has made. In such an approach, changes, trends, etc., can be recorded and, for example, may be used as reference for additional training or training another ML model.

As an example, a ML model can be re-trained (e.g., additionally trained) in an on-going manner. For example, consider training that can occur by a ML system in response to real time drilling activities. As an example, after each episode of training, an ML system can learn to improve performance for a current job and/or for a future job, which can aim to drill out more efficiently. As an example, a ML model may aim to reduce unnecessary/exceed energy which may lead to dissipation. Increasing dissipated energy can result in a higher possibility of failure (e.g., damage, etc.).

As an example, a ML system can generate a recommendation for a drilling parameter, for example, that can be sent to a driller screen for driller to follow the recommendation.

As an example, a ML system can be used as input for an automated system (see, e.g., FIGS. 3 and 4) and, for example, can be categorized as a prescriptive analytics system.

As an example, a system can use unsupervised learning, which may be in combination with reinforcement training (e.g., due to a factor of consequences). As compared to supervised training, the unsupervised training can include a capability to be more sensitive and stable if used properly.

As an example, supervised training can be more popular as to log synthetic generation, and unsupervised as to clustering, noting that clustering may involve both unsupervised and supervised learning.

As an example, during drilling out a PDDP, a common issue can be the impact between the bit cutting structure and combination of geometry and material of the plug. A ML model can account for such effects where, for example, maximum efficiency that can be reached can depend on interactions from these two components (the bit and plug (PDDP)).

As an example, a ML model can account for design of bit and a component/assembly where a ML system can operate with design information (e.g., output of a design framework, etc.) to achieve an improved result.

With inefficient drilling, a bit may get dull earlier which can cause a decrease in ROP and/or a loss in steerability. Such issues can result in a trip to surface to replace the bit (e.g., tripping out, replacing the bit and tripping in).

As an example, features for a ML system can include one or more surface drilling parameters. As an example, a number of features can depend on complexity of a problem. For example, WOB and torque that has been generated can be used as features, after correlation analysis process show the how these parameters connected to drilling risk and performance. These features from drilling parameters can have corresponding correlation analysis processes to see the connection between the component(s).

As to a depth system, it can be calibrated and a drilling procedure can be analyzed to determine if a SOP has been adhered to and/or to what degree adherence has been achieved. Such analyses can be performed, for example, before start of a drill out (e.g., of a PDDP, etc.).

As an example, vibration data from another tool (e.g., as used in an alarm system) may be utilized, for example, as a trigger for a system to hold on drilling parameter recommendation change. As an example, vibration data can tell that there is impact, or burst energy dissipated which may result on bit cutting structure damage. Such information can be utilized to control BHA movement when approaching a plug (e.g., or other component, assembly, etc.), and help to increase one or more drilling parameters smoothly.

As an example, a ML model of a ML system can be utilized to help prevent one or more types of problems, which may include a vibration problem.

While a method may involve use of simulated data, a simulation can be a result of a conditioned environment, which means that there can be assumptions, conditioning, which result in ignoring or covering an actual hidden factor. A hidden factor can be increasing because of the increasing problem complexity, the wider spectrum of the problem. A complex problem may include one or more hidden factors which may not be cover by simulation. Where simulated data are utilized, one or more approaches as to bias reduction may be implemented (e.g., assumptions as to categories can result in bias). Where bias may result, a ML system can be possibly directed away from an actual solution, especially for a more complex problem. As an example, a ML system may utilize actual data without using simulation data where, for example, a simulation is not suitable for detecting occurrence of an event or events that are associated with efficient drill outs. As an example, simulation data may be compared with process output, for example, to find out what is it actually making a result different. However, simulation tends to be lacking control in that the degree of an assumption and manipulation is not readily measurable, which can be noted when making a result comparison.

As an example, a ML system can produce a job classification which can tell the type of event, which can be represented by condition/combination of drilling parameters involved and depth position. As mentioned, a ML system may output a confidence level, which can tell the level of confidence of a classification, the higher the level means more confident. In such an approach, where a classification (e.g., event, etc.) has a low level of confidence, a driller may ignore the recommendation or take it into account as a history that may build a trend. For example, if a ML system issues notifications of the same event but as low confidence, with increasing confidence (e.g., for the latter), then a driller may take a recommended action or other action as warranted.

As an example, a classification may represent how energy has been transferred. For example, phenomena that cause energy to not be transferred properly may cause earlier dulling of a bit or undesirable debris generation, which can cause a change status on the classification and also confidence level. Such a condition may issue a trigger. As an example, a ML system can be designed to prevent failure, for example, without being specifically designed to detect a specific type of failure. As a ML system can be quite flexible (e.g., extensible), a problem that has specific condition may be detectable using proper training of a ML model or ML models of the ML system.

As an example, a ML system can use classification provided by a neural network or neural networks. As an example, layer and weighting may be unspecified, as for supervised learning.

As an example, a framework such as the TECHLOG framework may include and/or be operatively coupled to a ML system that can receive input and provide output as to a drill out.

As an example, a workflow can include accessing a ML system (e.g., directly or indirectly) via a base location, for example, locally (at rig) if there is hardware and software installed. As an example, an approach may be utilized that implements one or more actions downhole, for example, where a ML model can be of a size sufficient for storage in memory of a downhole tool and implemented by a downhole processor. In such an approach, a closed loop may be implemented by a downhole tool that can adjust one or more drilling parameters automatically using output of a trained ML model. As an example, a downhole tool approach may aim to detect a tool problem and/or to prevent failure.

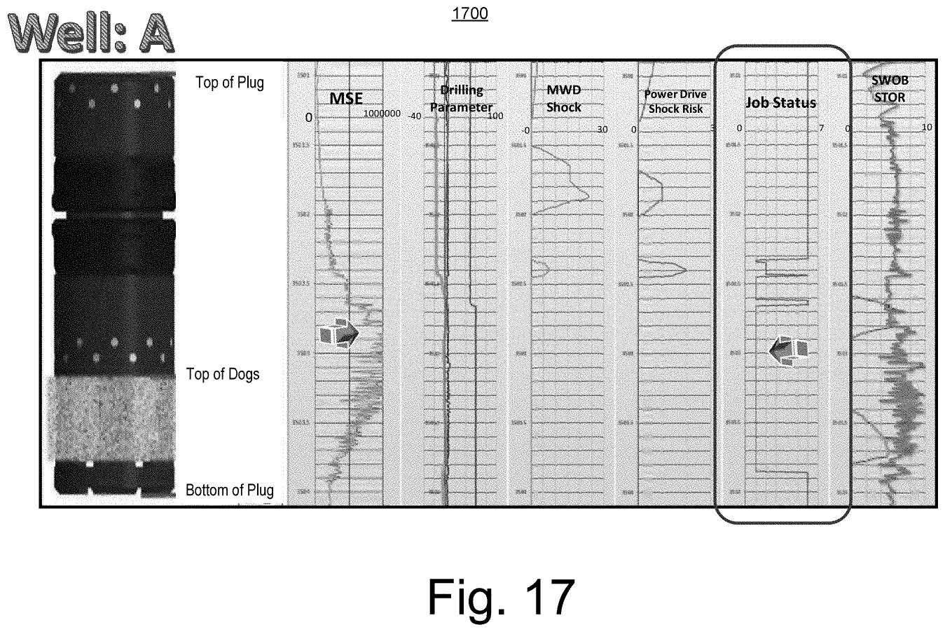

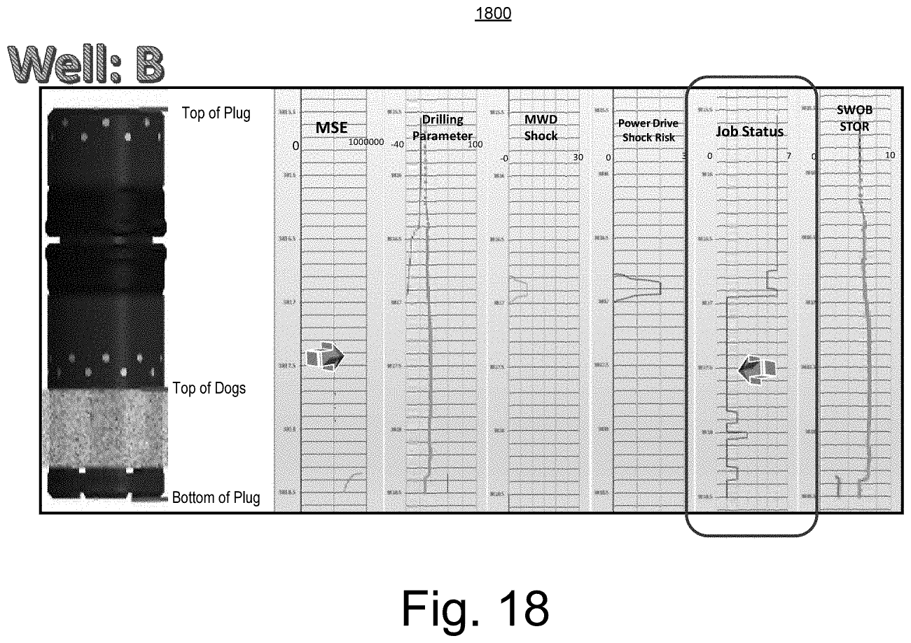

FIGS. 17, 18 and 19 show GUIs 1700, 1800 and 1800 for wells labeled A, B and C. The well C is the well that the ML system has connection with in real time so there is a data stream from the rig. As to wells A and B, these were not connected in real time. The C well run was performed to test the real time ML system. As shown, due to problems that happened in well A and well B, some instruction/recommendation has been sent for drilling well C, for example, to reduce risk of such problems occurring.

As an example, execution of instruction(s)/recommendation(s) at well C can be monitored in real time. As a result, the problem on well A and the problem on well B did not arise in well C. The problem on well A was a steering problem where the bit could not get the directional target and also vibration detected when the bit started to drill out a PDDP. To complete the drill out, the BHA in well A was pulled out to change the bit (e.g., it could not finish the section). The problem on well B was from debris caused by drill out of the PDDP, which came to the surface in a relatively large piece, which has potential to affect BHA performance including directional capabilities (e.g., steerability, DLS, etc.).

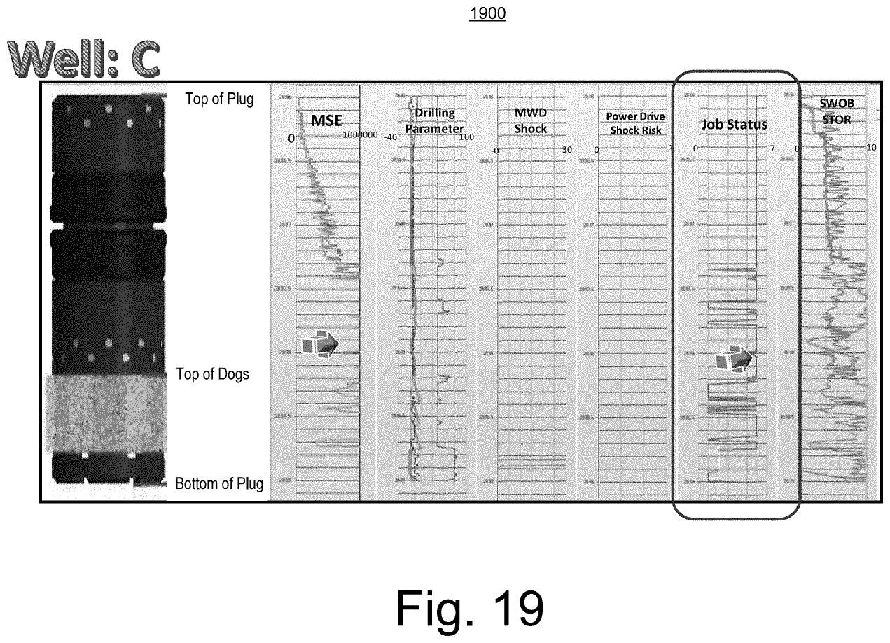

As shown in FIG. 19, well C does not have either of the problems as in well A and well B. The result of the job status from well C also shows improvement in job status, compared to the wells A and B. The data for well C show a more stable job status, which means less risk and a higher likelihood of improved drill out (e.g., improved efficiency, etc.).

As an example, a ML system can be run in real time, received drilling data from a rigsite, processing the data, determining job status and confidence factor and recommending a drilling parameter (or drilling parameters) via a GUI rendered to a display in a doghouse or rig floor for a driller to follow the recommendation. Such a ML system can monitor drilling energy (e.g., mechanical specific energy (MSE)), which may be maintained inside a safe zone.

As an example, a ML system can utilize AI to provide prescriptive analytics to maintain a drill out drilling activity as a “good” run. Such an approach can aim to preserve bit life (reduced dulling), maintain steerability of a bit (and/or BHA in general) and finish a section in single run, as desired.

As an example, a ML system can use a combination of unsupervised learning (e.g., DNN model) and reinforcement learning to provide prescriptive analytics and, for example, recommendations to achieve improved or desired performance.

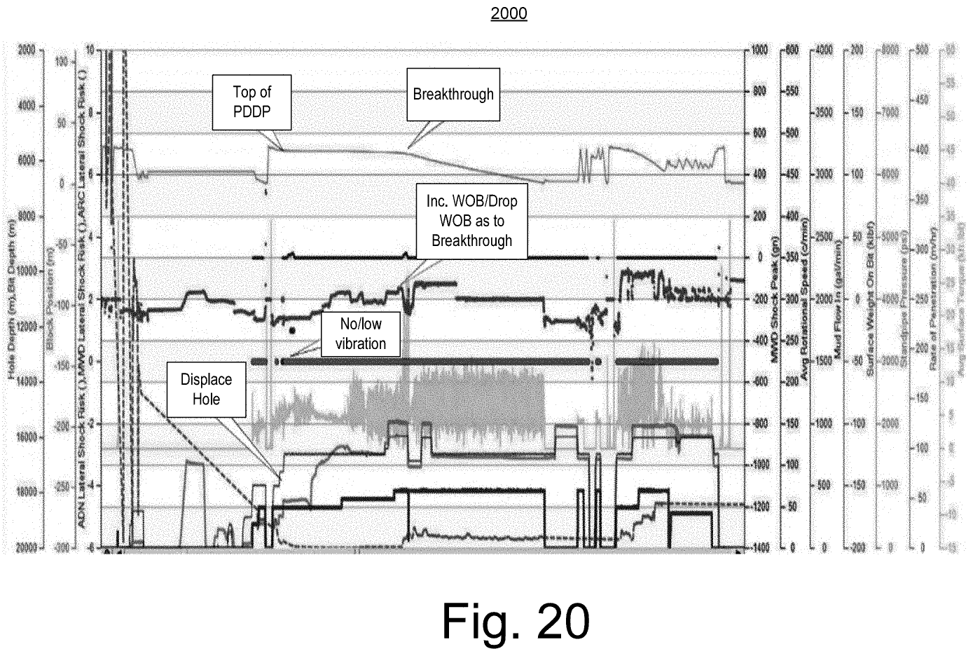

FIG. 20 shows a GUI 2000 of various types of data as acquired in real time as associated with a drill out operation where a top of PDDP and breakthrough are shown with respect to depth.

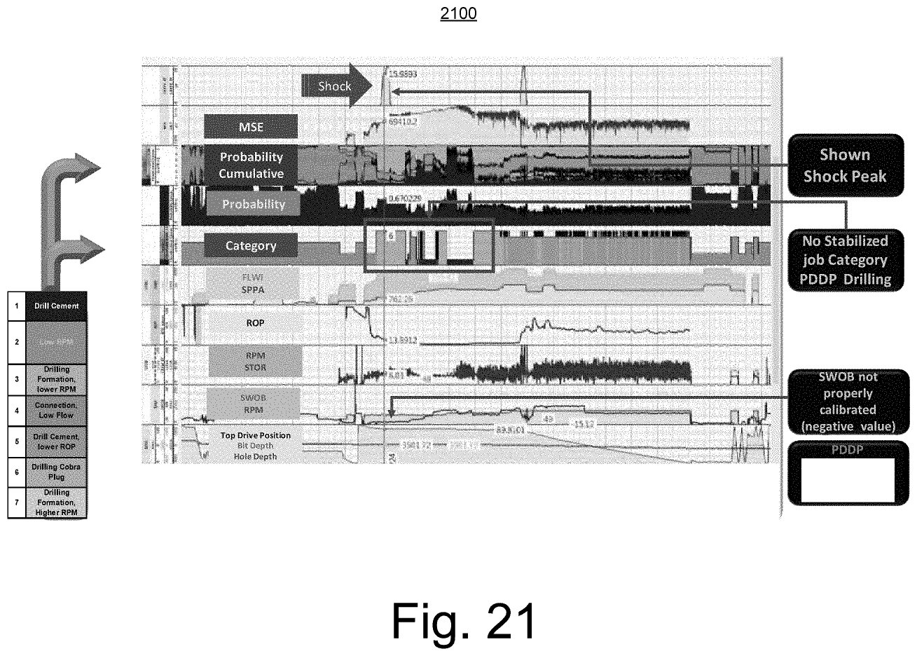

FIG. 21 shows a GUI 2100 of various types of data as acquired in real time as associated with a drill out operation.

One or more of the types of data as shown in FIGS. 17 to 21 may be utilized by a ML system for training and/or providing guidance as to drill outs.

As shown in FIGS. 17 to 19, the job status for well C is improved in contrast to the job statuses for well A and well B. As an example, a driller may view a job status as an output of a ML system that includes a trained ML model. As shown in the system 1100, the ML system 1110 can output a job status as an indicator that is readily ascertained by a driller when rendered versus time and/or depth to a display. As shown in the system 1100, the ML system 1110 can also output one or more variables, which can include one or more drilling parameters that can be utilized to control, adjust, etc., a drill out operation. As indicated, the ML system 1110 can output a confidence status, which may be associated with a job status such that a driller can determine a confidence as to job status. For example, if a job status is “good” (e.g., a high numeric value) and confidence level is high (e.g., 70 of 100 or 0.7 or 1.0 or more), then a driller can continue accordingly. Whereas, if a job status is “bad” (e.g., a low numeric value) and confidence level is high, then the driller may assess an output variable or output variables that may be inherently in a recommendation or recommendations and adjust a drill out accordingly.

As an example, a method can include receiving data, associated with a drill out, by a trained machine learning model; and generating, via the trained machine learning model, output that characterizes the drill out. As an example, a system can include a processor; memory accessible to the processor; processor-executable instructions stored in the memory and executable by the processor to instruct the system to: receive data, associated with a drill out, by a trained machine learning model; and generate, via the trained machine learning model, output that characterizes the drill out. As an example, one or more computer-readable storage media can include computer-executable instructions executable to instruct a computing system to: receive data, associated with a drill out, by a trained machine learning model; and generate, via the trained machine learning model, output that characterizes the drill out.

As an example, a method can include rendering a representation of output of a trained ML model to a display.

As an example, a method can include generating output via a trained ML model that includes a drill out status and/or one or more drilling parameters.

As an example, a method can include training a machine learning model, which may include unsupervised learning and may include reinforcement training.

As an example, a ML model may include an input for mechanical energy such as MSE data or other mechanical energy data associated with a drill out.

As an example, a trained machine learning model can include a trained neural network model.

As an example, a trained machine learning model may be a trained ML model that is stored in a downhole tool utilized to perform drill out. In such an example, the trained ML model may be part of a control system that operates in a closed loop downhole.

As an example, a drill out can be or include a drill out of a plug.

As an example, output generated by a trained ML model can be or can include a recommendation or recommendations and/or a control instruction or control instructions.

As an example, a method can include adjusting at least one drilling parameter of a drill out based at least in part on output generated by a trained ML model.

As an example, a drill out can be a drill out of an assembly that includes a plurality of different materials. In such an example, the plurality of different materials can include at least one metallic material and at least one polymeric material.

As an example, a method can include drilling formation after performing a drill out where the drilling formation and the performing the drill out utilize the same drill bit (e.g., without tripping out and tripping in).

As an example, a method can include performing a cementing operation prior to a drill out.

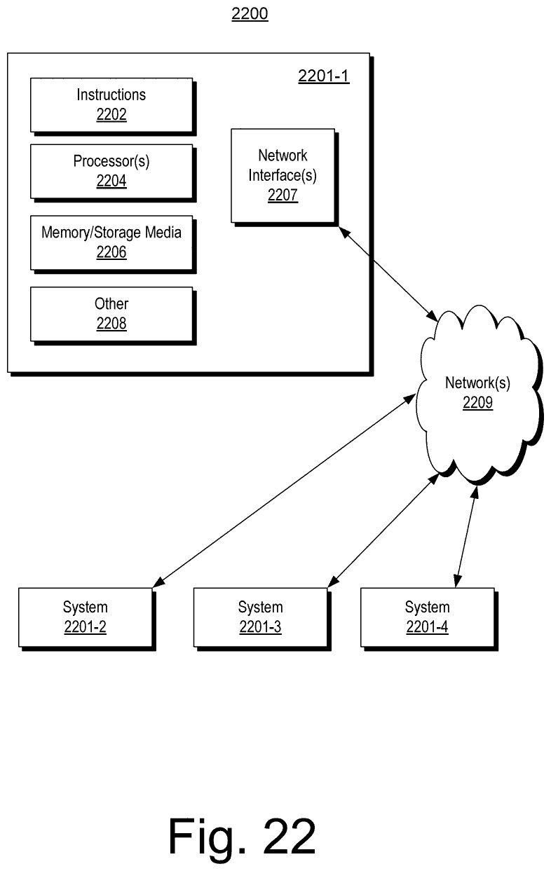

In some embodiments, a method or methods may be executed by a computing system. FIG. 22 shows an example of a system 2200 that can include one or more computing systems 2201-1, 2201-2, 2201-3 and 2201-4, which may be operatively coupled via one or more networks 2209, which may include wired and/or wireless networks.

As an example, a system can include an individual computer system or an arrangement of distributed computer systems. In the example of FIG. 22, the computer system 2201-1 can include one or more sets of instructions 2202, which may be or include processor-executable instructions, for example, executable to perform various tasks (e.g., receiving information, requesting information, processing information, simulation, outputting information, etc.).

As an example, a set of instructions may be executed independently, or in coordination with, one or more processors 2204, which is (or are) operatively coupled to one or more storage media 2206 (e.g., via wire, wirelessly, etc.). As an example, one or more of the one or more processors 2204 can be operatively coupled to at least one of one or more network interface 2207. In such an example, the computer system 2201-1 can transmit and/or receive information, for example, via the one or more networks 2209 (e.g., consider one or more of the Internet, a private network, a cellular network, a satellite network, etc.).

As an example, the computer system 2201-1 may receive from and/or transmit information to one or more other devices, which may be or include, for example, one or more of the computer systems 2201-2, etc. A device may be located in a physical location that differs from that of the computer system 2201-1. As an example, a location may be, for example, a processing facility location, a data center location (e.g., server farm, etc.), a rig location, a wellsite location, a downhole location, etc.

As an example, a processor may be or include a microprocessor, microcontroller, processor component or subsystem, programmable integrated circuit, programmable gate array, or another control or computing device.

As an example, the storage media 2206 may be implemented as one or more computer-readable or machine-readable storage media. As an example, storage may be distributed within and/or across multiple internal and/or external enclosures of a computing system and/or additional computing systems.

As an example, a storage medium or storage media may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLUERAY disks, or other types of optical storage, or other types of storage devices.

As an example, a storage medium or media may be located in a machine running machine-readable instructions, or located at a remote site from which machine-readable instructions may be downloaded over a network for execution.

As an example, various components of a system such as, for example, a computer system, may be implemented in hardware, software, or a combination of both hardware and software (e.g., including firmware), including one or more signal processing and/or application specific integrated circuits.

As an example, a system may include a processing apparatus that may be or include a general purpose processors or application specific chips (e.g., or chipsets), such as ASICs, FPGAs, PLDs, or other appropriate devices.

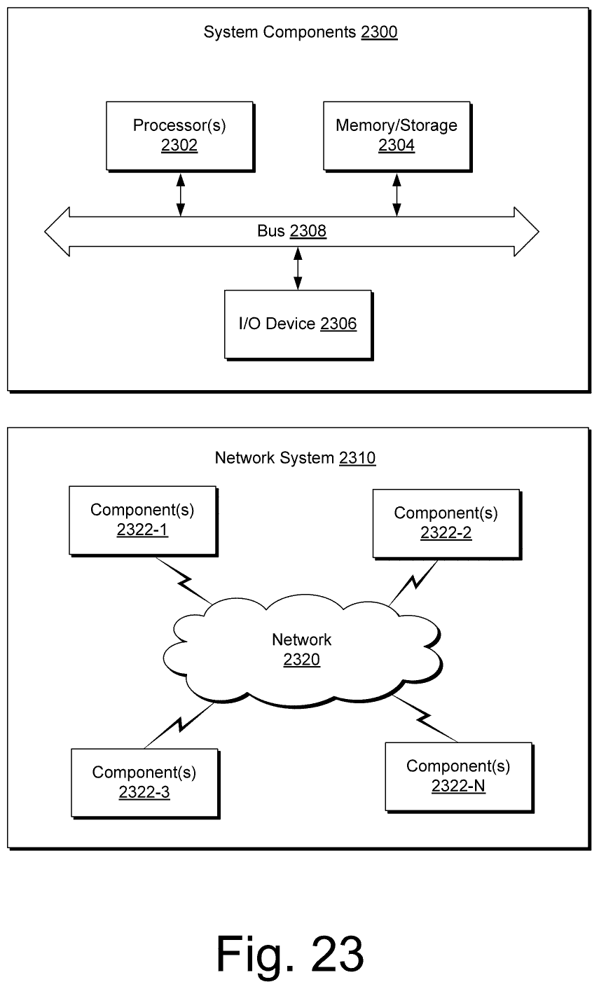

FIG. 23 shows components of a computing system 2300 and a networked system 2310. The system 2300 includes one or more processors 2302, memory and/or storage components 2304, one or more input and/or output devices 2306 and a bus 2308. According to an embodiment, instructions may be stored in one or more computer-readable media (e.g., memory/storage components 2304). Such instructions may be read by one or more processors (e.g., the processor(s) 2302) via a communication bus (e.g., the bus 2308), which may be wired or wireless. The one or more processors may execute such instructions to implement (wholly or in part) one or more attributes (e.g., as part of a method). A user may view output from and interact with a process via an I/0 device (e.g., the device 2306). According to an embodiment, a computer-readable medium may be a storage component such as a physical memory storage device, for example, a chip, a chip on a package, a memory card, etc.

According to an embodiment, components may be distributed, such as in the network system 2310. The network system 2310 includes components 2322-1, 2322-2, 2322-3, . . . 2322-N. For example, the components 2322-1 may include the processor(s) 2302 while the component(s) 2322-3 may include memory accessible by the processor(s) 2302. Further, the component(s) 2322-2 may include an I/O device for display and optionally interaction with a method. The network may be or include the Internet, an intranet, a cellular network, a satellite network, etc.

As an example, a device may be a mobile device that includes one or more network interfaces for communication of information. For example, a mobile device may include a wireless network interface (e.g., operable via IEEE 802.11, ETSI GSM, BLUETOOTH, satellite, etc.). As an example, a mobile device may include components such as a main processor, memory, a display, display graphics circuitry (e.g., optionally including touch and gesture circuitry), a SIM slot, audio/video circuitry, motion processing circuitry (e.g., accelerometer, gyroscope), wireless LAN circuitry, smart card circuitry, transmitter circuitry, GPS circuitry, and a battery. As an example, a mobile device may be configured as a cell phone, a tablet, etc. As an example, a method may be implemented (e.g., wholly or in part) using a mobile device. As an example, a system may include one or more mobile devices.

As an example, a system may be a distributed environment, for example, a so-called “cloud” environment where various devices, components, etc. interact for purposes of data storage, communications, computing, etc. As an example, a device or a system may include one or more components for communication of information via one or more of the Internet (e.g., where communication occurs via one or more Internet protocols), a cellular network, a satellite network, etc. As an example, a method may be implemented in a distributed environment (e.g., wholly or in part as a cloud-based service).

As an example, information may be input from a display (e.g., consider a touchscreen), output to a display or both. As an example, information may be output to a projector, a laser device, a printer, etc. such that the information may be viewed. As an example, information may be output stereographically or holographically. As to a printer, consider a 2D or a 3D printer. As an example, a 3D printer may include one or more substances that can be output to construct a 3D object. For example, data may be provided to a 3D printer to construct a 3D representation of a subterranean formation. As an example, layers may be constructed in 3D (e.g., horizons, etc.), geobodies constructed in 3D, etc. As an example, holes, fractures, etc., may be constructed in 3D (e.g., as positive structures, as negative structures, etc.).

Although only a few examples have been described in detail above, those skilled in the art will readily appreciate that many modifications are possible in the examples. Accordingly, all such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

What is claimed is:

1. A method comprising:
receiving data, associated with a drill out, by a trained machine learning model; and
generating, via the trained machine learning model, output that characterizes the drill out.

2. The method of claim 1 comprising rendering a representation of the output to a display.

3. The method of claim 1 wherein the output comprises a drill out status.

4. The method of claim 1 wherein the output comprises a drilling parameter.

5. The method of claim 1 comprising training the machine learning model.

6. The method of claim 5 wherein the training comprises unsupervised learning.

7. The method of claim 6 wherein the training comprises reinforcement training.

8. The method of claim 1 wherein the data comprise mechanical energy data.

9. The method of claim 1 wherein the trained machine learning model comprises a trained neural network model.

10. The method of claim 1 wherein the trained machine learning model is stored in a downhole tool utilized to perform the drill out.

11. The method of claim 1 wherein the drill out comprises a drill out of a plug.

12. The method of claim 1 wherein the output comprises a recommendation.

13. The method of claim 1 wherein the output comprises a control instruction.

14. The method of claim 1 comprising adjusting at least one drilling parameter of the drill out based at least in part on the output.

15. The method of claim 1 wherein the drill out comprises a drill out of an assembly that comprises a plurality of different materials.

16. The method of claim 15 wherein the plurality of different materials comprise at least one metallic material and at least one polymeric material.

17. The method of claim 1 comprising drilling formation after performing the drill out wherein the drilling formation and the performing the drill out utilize the same drill bit.

18. The method of claim 1 comprising performing a cementing operation prior to the drill out.

19. A system comprising:
a processor;
memory accessible to the processor;
processor-executable instructions stored in the memory and executable by the processor to instruct the system to:
receive data, associated with a drill out, by a trained machine learning model; and
generate, via the trained machine learning model, output that characterizes the drill out.

20. One or more computer-readable storage media comprising computer-executable instructions executable to instruct a computing system to:
receive data, associated with a drill out, by a trained machine learning model; and
generate, via the trained machine learning model, output that characterizes the drill out.
